(19) United States
(12) Patent Application Publication
(10) Pub. No.: US 2026/0032179 A1
(43) Pub. Date: Jan. 29, 2026

(54) SYSTEMS AND METHODS FOR MISSION MANAGEMENT IN A COMMUNICATION NETWORK

(71) Applicant: Huawei Technologies Co., Ltd., Shenzhen (CN)

(72) Inventors: Xu Li, Nepean (CA); Weisen Shi, Ottawa (CA); Chenchen Yang, Ottawa (CA); Hang Zhang, Ottawa (CA)

(21) Appl. No.: 19/343,402

(22) Filed: Sep. 29, 2025

Related U.S. Application Data
(63) Continuation of application No. PCT/CN2023/085500, filed on Mar. 31, 2023.

(51) Int. Cl. H04L 67/51; H04L 65/1063; H04L 65/1069

(52) U.S. Cl. CPC H04L 67/51; H04L 65/1063; H04L 65/1069

(57) ABSTRACT

A communication network may support one or more missions. Each mission including one or more building blocks that may either be a task or a sub-mission. The sub-mission may include one or more sub-mission building blocks. In some embodiments, a single network entity is operative to define all required details of the mission in the form of a mission specification. In some embodiments, a first network entity defines a mission intent that includes or describes a goal of the mission. A second network entity is operative to receive the mission intent and to specify, based on available network resources, a mission specification operative to provide, achieve, and/or accomplish the mission intent.

### CROSS-REFERENCE TO RELATED APPLICATION

This application is a continuation of International Application No. PCT/CN2023/085500, filed on March 31, 2023, the disclosure of which is hereby incorporated by reference in its entirety.

### TECHNICAL FIELD

This invention pertains generally to the field of computerized communication systems and in particular to communication infrastructures for implementing anything-as-a-service (Xaas) service delivery.

### BACKGROUND

Current wireless communication systems (also referred to as wireless systems), such as 5^{th} Generation (5G) systems as defined by the 3^{rd} Generation Partnership Project (3GPP) are designed to provide connectivity services and are generally managed and operated by a single party, referred to as a network operator. It is anticipated that future wireless systems (e.g. 6^{th} Generation (6G) systems to be defined by the 3GPP) will go beyond connectivity provisioning to offer various new services. It is also anticipated the future wireless system may be operated by multiple parties, for example with different parties operating a different portion of the wireless system to offer certain services. These services may be provided for the system’s internal use, an operating party’s use, or for an end customer’s use.

However, current wireless systems and infrastructure require further development to support the above scenario and comparable scenarios. Such development is not straightforward and can require solving of a variety of technical and design problems.

To address this issue, it is expected that the computing and processing works of heterogeneous services can be decoupled from centralized cloud server nodes, and be deeply deployed into the network or edge (e.g. on radio node). As the next-generation mobile communications system, 6G is expected to go far beyond providing communication pipelines or connectivity to intelligence. 6G will employ a X-centric architecture to enable computing and processing capabilities of different services in a distributed and collaborated manner. The X-centric architecture is defined to support anything as a service (XaaS) services (or service in short) with heterogeneous processing and computing requirements. For instance, NET4AI (also referred to as Network AI) is a typical XaaS service that aims to intelligently connect distributed intelligent nodes/agents in the network to proliferate large-scale deployment of AI in all industries. In another instance, data analytics and management (DAM) is another XaaS service that aims to collect and analyze data from different sources to support various applications, e.g. AI applications. To support XaaS services, the core network (CN)/radio access network (RAN) in 6G will be enabled with computing capabilities (i.e., modules/nodes to provide computing resources and management of computing procedures) and be redesigned with new control/management (C/M) plane functions to schedule/coordinate the network-based computing and processing capabilities.

Moreover, in some cases both the computing and processing capabilities, and part of the corresponding control functions for an XaaS service can be provided by third-party providers (e.g., an independent AI solution provider may design their own module containing the corresponding processing and control functions for a XaaS service and plug it in the 6G CN/RAN network). To support the third-party provided XaaS service modules, the future 6G networks should have a global control functionality across multiple XaaS services and define the general procedures of processing and control the XaaS services.

Existing prior art is focusing on a (or a class of) specific service(s) and defines a set of dedicated system functions and procedures. Since the future X-centric network must support heterogeneous services, i.e. XaaS services, in one architecture, it is costly and inefficient to independently implement the known dedicated systems. Therefore, a general network architecture with corresponding processing and control functions suitable for all XaaS services is desirable.

In some prior art systems, the uses/selections of required processing/control functions are statically configured or pre-determined to achieve a specific purpose (or to solve a problem). However, in future network where multiple XaaS services are running simultaneously, the available computation and processing resources (e.g., network entities realizing processing/computing functions) can be limited and change dynamically. To address this issue, methods that can dynamically select processing/control functions for the execution of XaaS service are desirable.

Some prior art systems involve processing/control functions that are dedicated for a specific service. However, the future X-centric network should be able solve more complex problems that involve heterogeneous processing/control functions originally designed for different XaaS services. A mechanism that enables cooperative working among processing/control functions of multiple XaaS services is desirable.

Therefore, there is a need for a method, apparatus and system for implementing an XaaS service delivery, that obviates or mitigates one or more limitations in the prior art.

This background information is intended to provide information that may be of possible relevance to the present disclosure. No admission is necessarily intended, nor should be construed, that any of the preceding information constitutes prior art against the present disclosure.

### SUMMARY

In embodiments of the present disclosure, systems and methods for provisioning mission information is provided. In embodiments of the present disclosure, systems and methods for allocating/reserving mission resources to support a mission execution is presented.

In embodiments of the present disclosure, systems and methods are provided that describe how mission information may be provisioned to a communication system (e.g. a cellular system), and the content of the mission information being provisioned. In some embodiments, information regarding systems and methods for mission resource preparation and allocation are described. In some embodiments, systems and methods for intra-mission connection and access or participation by entities external to the mission are described.

In some embodiments, a communication network may support one or more missions. Each mission including one or more building blocks that may either be a task or a sub-mission. The sub-mission may include one or more sub-mission building blocks. In some embodiments, a single network entity is operative to define all required details of the mission in the form of a mission specification. In some embodiments, a first network entity defines a mission intent that includes or describes a goal of the mission. A second network entity is operative to receive the mission intent and to specify, based on available network resources, a mission specification operative to provide, achieve, and/or accomplish the mission intent. In some aspects, the second network entity comprises a mission information handler (MIH). In some embodiments, the MIH is referred to as a mission exposure function (MEF).

In some aspects, the MIH is operative to receive a mission intent, translate the mission intent into a mission specification to specify the mission, and prepare necessary mission resources to support an execution of the mission.

In some aspects, the MIH is operative to translate the mission intent by communicating with one or more service control functions (SCFs) operative to provide services related to the received mission intent.

In some aspects, the MIH is operative to send a mission information to one or more service control functions operative to prepare network resources related to the specific mission. In some aspects, the MIH is operative to send task information to one or more network functions to enable task slice creation on the network.

In some embodiments, the MIH is operative to send information about a mission (i.e. a mission information) to a mission data repository (MDR) for storage of the mission information. In some aspects, a mission manager (MM) may be operative to obtain the mission information and/or task information from the MDR in order to manage the mission.

In some embodiments, a method is provided for mission provisioning in a communication network. The method may include: receiving mission information related to a mission; determining whether the mission information can be accepted based on content included in the mission information; and, sending a response to an application function (AF) indicating whether the mission can be accepted.

In some embodiments, a method is provided for mission provisioning in a communication network. The method may include: receiving, from a mission information handler (MIH) mission information including a mission intent that defines a goal of a mission; generating a mission specification based on the mission intent; and sending, to the MIH, the generated mission specification.

In some embodiments, a method is provided for mission provisioning in a communication network. The method may include: receiving mission information related to a mission; validating the mission information to determine if the mission information is specified and/or valid; when the mission information is valid and the mission information is not specified, performing a mission intent translation to specify the mission information; and, sending the specified mission information to a mission data repository (MDR) for storage. In some aspects, the mission information is specified when the mission information includes a mission specification. In some aspects, the method is performed by a mission information handler (MIH).

In some embodiments, a method for mission resource preparation in a communication network is provided. The method may include: identifying a mission resource triggering condition; sending, for each task of a mission, a task slice creation request to a task slice creation SCF to create a corresponding task slice; and, storing task slice information corresponding to each created task slice in a network registry function (NRF). In some aspects, the method may be performed by a mission information handler (MIH).

In some embodiments, a method is provided for managing an execution of a mission in a communication network. The method may include: receiving a mission management request; obtaining, based on the mission management request, mission information from an MDR; obtaining, based on the obtained mission information, task slice information and sub-mission slice information from an NRF; and establishing an intra-mission connection within a mission slice based on the mission information, task slice information, and sub-mission slice information. In some aspects, the method may be performed by a mission manager (MM).

In some embodiments, an apparatus is provided that includes one or more processors coupled with a memory storing instructions when executed by the one or more processors cause the one or more processors to perform at least one of the above methods.

In some embodiments, a medium storing instructions is provided that, when executed by an apparatus, cause the apparatus to perform at least one of the above methods.

### BRIEF DESCRIPTION OF THE DRAWINGS

FIGS. 1A and 1B illustrate are simplified schematics of a mission hierarchy, in accordance with embodiments of the present disclosure.

FIG. 2 is an illustrative embodiment of a simplified schematic of a mission graph.

FIG. 3 is an illustrative embodiment of a simplified schematic of a mission slice.

FIG. 4 is an illustrative embodiment of a simplified schematic of a service module.

FIG. 5A and 5B are illustrative embodiments of simplified schematics of communication system architectures.

FIG. 6 is an illustrative embodiment of a simplified schematic of mission information provisioning and mission resource preparation.

FIG. 7 is an illustration of an embodiment of a simplified schematic of a mission management framework (MMF).

FIG. 8 is an illustration of an embodiment of a simplified schematic of mission / service information exposure.

FIG. 9 illustrates a computing device that may perform computing or related operations according to embodiments of the present disclosure.

It will be noted that throughout the appended drawings, like features are identified by like reference numerals.

### DETAILED DESCRIPTION OF THE ILLUSTRATIVE EMBODIMENTS

As used herein, the term “anything-as-a-service,” i.e. “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and interconnectable with one another, generally without requiring retrofit or redesign. An open system architecture is one approach for achieving a modular design in which modules are configured to be interoperable.

The term “X-centric” refers to the capability of embodiments to be reconfigurable so that they are either infrastructure-provider centric, third-party centric, customer centric, or the like, or a combination thereof. Other types of configurations may also be supported. Multiple possible mappings between parties and roles are thus supported, with different X-centric scenarios corresponding to different mappings. This facilitates an architectural openness with support for multiple operation scenarios.

According to embodiments of the present disclosure, there is provided a networked computing and communication system comprising multiple different types of modules in an open system architecture. On one layer, infrastructure modules each provide a respective infrastructure resource as service. Infrastructure resources may include real computing, communication or data storage resources. On another layer, service modules each provide a respective functionality as service. Service module functionalities may be functionalities that can be utilized by an end user or other module. The service modules may utilize at least one of the infrastructure resources as service. On another layer, management and control modules each provide a respective management or control resource as service. Management and control resources may be used to manage other modules, missions of modules, module operations, or other management or control tasks. At least one of the management and control modules may provide its respective management or control resource as service to at least one of the infrastructure modules or the service modules. Each module may provide its functionality as a service, on an as-needed basis, to one, some or all modules of the same layer or of different layers. Modules can be interconnected to provide services to one another in a configurable manner depending on operational requirements. Different modules can be provided or operated by different parties, in order to provide for different X-centric configurations, which may be party-centric configurations.

According to embodiments of the present disclosure, a networked computing and communication system may be provided that includes a control/management (C/M) plane and a mission data plane. The C/M plane includes a mission manager (MM) that is configured to manage a mission, which comprises tasks associated with heterogenous services (different services) provided by respective XaaS modules. The mission data plane includes processing functions (PFs) that are comprised in the tasks. Each XaaS module comprises at least one PF. Each PF is configured to interface with at least one of: another PF, a device and an application server. The MM is configured to manage the mission by scheduling and coordinating the tasks associated with the heterogenous services.

In some embodiments, the MM is configured to dynamically schedule and coordinate tasks in accordance with dynamic resource conditions or dynamic network conditions. In some embodiments, the MM is configured to schedule and coordinate the tasks in accordance with a pre-determined workflow. In some embodiments, the MM is centrally deployed in a network entity. In some embodiments, the MM is deployed at multiple network entities. The configuration of the MM allows the system to adapt rapidly to changes in the network resources or conditions.

In some embodiments, the C/M plane defines a network registry (NRF) function configured to store and maintain pre-determined data associated with at least one of: the PFs, the DPFs, the tasks and the mission. In some embodiments, the C/M plane defines a network exposure function (NEF) configured to manage an interconnection between the XaaS modules and application functions (AFs), the AFs configured to create a mission, trigger a mission or both create a mission and trigger the mission. In some embodiments, the C/M plane defines a connectivity manager (CM) configured to manage an access of a device to the mission.

In accordance with another embodiment of the present disclosure, there is a system that includes a mission data plane (MDP). The MDP including processing functions (PFs), each associated with one or more XaaS services, and configured to interface with at least another PF, a device and/or an application server. The MDP also includes data plane functions (DPFs), each DPF configured to interface a PF of a first XaaS service to a PF of a different XaaS service. The system comprises a control/management (C/M) plane that includes one or more XaaS service controller functions (XCs) each associated with one of the XaaS services and configured to control a PF of the associated XaaS service. The data plane and the C/M plane are configured to execute a mission comprising tasks, each task being related to an execution of at least on PF. The system is part of a network, which has a network architecture. Advantageously, the arrangement of the MDP and the C/M plane, as well as the configuration of the PFs, the device, the application server and the XC allow for the support and execution of the XaaS services in the network.

The device, the AF, the NEF, and the MM are comprised in network elements in the network. The network elements further comprising at least one of: a network registry function (NRF), XaaS service controllers (XCs), processing functions (PFs), data plane functions (DPFs), a device, and an application server (AS).

According to embodiments of the present disclosure, there is provided a networked computing and communication system comprising multiple different types of modules in an open system architecture. On one layer, infrastructure modules each provide a respective infrastructure resource as service. Infrastructure resources may include real computing, communication or data storage resources. On another layer, service modules each provide a respective functionality as service. Service module functionalities may be functionalities that can be utilized by an end user or other module. The service modules may utilize at least one of the infrastructure resources as service. On another layer, management and control modules each provide a respective management or control resource as service. Management and control resources may be used to manage other modules, missions of modules, module operations, or other management or control tasks. At least one of the management and control modules may provide its respective management or control resource as service to at least one of the infrastructure modules or the service modules. Each module may provide its functionality as a service, on an as-needed basis, to one, some or all modules of the same layer or of different layers. Modules can be interconnected to provide services to one another in a configurable manner depending on operational requirements. Different modules can be provided or operated by different parties, in order to provide for different X-centric configurations, which may be party-centric configurations.

In accordance with an embodiment of the present disclosure, there is provided an apparatus comprising one or more processors coupled with a memory storing instructions that when executed by the one or more processors cause the one or more processors to perform a method according to any one of the method embodiments described herein. In accordance with another embodiment of the present disclosure, there is provided a medium storing instructions that when executed by an apparatus cause the apparatus to perform a method according to any one of the method embodiments described herein.

In the context of the present disclosure, a device may be any terminal user equipment of the network such as, for example, a cellphone, a personal computer or a laptop, an IoT device like sensor, smart home devices, a vehicle connected to the vehicular network, an AR/VR (augmented reality/virtual reality) device, a satellite, etc. Any electrical device can be recognized as a device by the network.

Embodiments of the present disclosure describe systems and methods for mission management. The management may include, for instance: i) how mission information is provisioned to a communication system and the content of the mission information; ii) mission resource preparation; and, iii) intra-mission connection establishment.

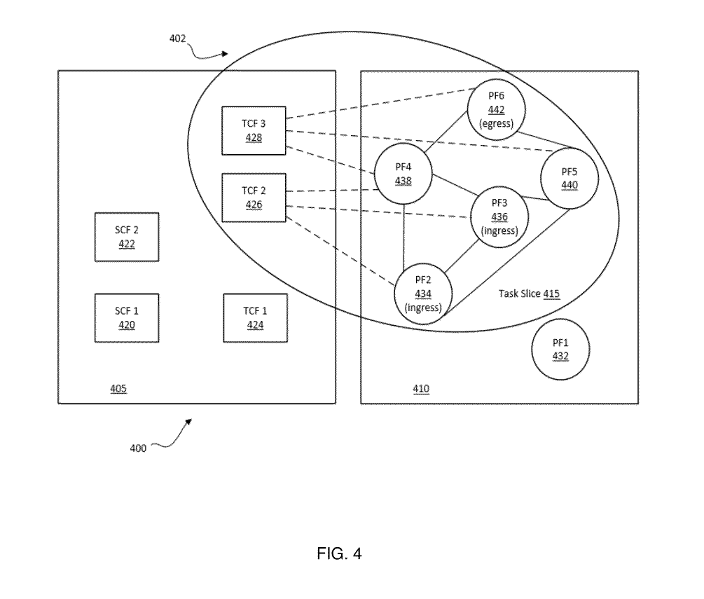

In the context of the present disclosure, a mission specifies a procedure of network-based computing, wherein one or multiple services are utilized to achieve a goal. The mission may be executed, over a mission slice associated with the mission, to achieve the goal of the mission. The goal is considered to be associated with the mission and may be referred to as the goal of the mission. Each of the one or multiple services utilized by the mission may be offered by a service module (described in more detail with reference to FIG. 4 below).

In the context of the present disclosure, a service (e.g. a service utilized by the mission) is offered by a service module to solve one or multiple problems. The one or multiple problems are referred to as service problem(s) and are associated with the service.

In the context of the present disclosure, a task is a specific procedure or functionality to be executed to complete a mission. A task is supported by a service (e.g. an XaaS service described above), the service being among one or multiple services utilized by the mission. The task is associated with a goal, which is referred to as the goal of the task and is related to at least one service problem associated with the service. The task is executed, over a task slice associated with the task, to achieve the goal of the task. In an X-centric network, each task is associated with an XaaS service, and an execution of the task involves one or multiple processing functions (PFs), data plane functions (DPFs), device(s), and application servers (ASs), which may be inter-dependent. In some embodiments, a processing function is also known as processing service function (PSF), and in those embodiments the terms PF and PSF may be considered to be equivalent. Each XaaS service can support one or multiple tasks.

A mission includes one or multiple building blocks (BBs). Each of the one or multiple BBs is either a task or a sub-mission. A task in the mission is supported by a service, the service being among the one or multiple services utilized by the mission.

A mission may include a BB that is made up of another mission, that may be referred to as a sub-mission for the mission. The sub-mission included in the mission corresponds to a reusable mission that may be reused by the mission as a BB. As a reusable mission, the sub-mission may be used by other missions as may be required. Typically, a sub-mission may be considered as equivalent to the corresponding reusable mission, unless otherwise defined or modified.

A mission is referred to as reusable if the reusable mission can be embedded or included in another mission as a sub-mission. A sub-mission included in a mission corresponds to another mission that is reused by the mission as a BB. When the reusable mission is included in another mission (as a sub-mission), the mission is said to be reusing the reusable mission (i.e. the sub-mission). The reusable mission may be reused either in an exclusive reuse mode or in a shareable reuse mode.

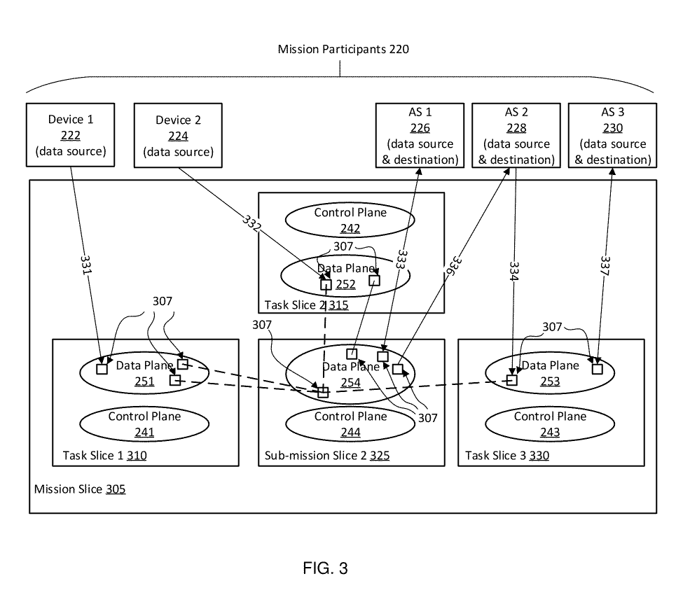

In an exclusive reuse mode, an instance of the reusable mission should be embedded/included in at most one mission instance. That mission instance being an instance of another mission that reuses the reusable mission. A mission instance may be referred to as a mission slice, as further described below in reference to FIG. 3. A mission slice may include one or more task slices and/or sub-mission slices. Each of the task slices corresponds to a task of the mission. Each of the sub-mission slices corresponds to a sub-mission of the mission. The task slices and sub-mission slices may collectively be referred to as building block slices for ease of presentation.

In a sharable reuse mode, an instance of the reusable mission can be embedded/included in multiple mission instances. Each of multiple mission instances being an instance of another mission that may reuse the reusable mission.

In some embodiments, a reusable mission may only operate when included in another mission as a sub-mission. In some embodiments, the reusable mission may operate as a mission, and/or may be embedded or included in a mission as a sub-mission, depending upon requirements.

When a mission includes multiple tasks as BBs, the multiple tasks may be supported by a same service or by different services. A service is offered/implemented through a service module. In embodiments where tasks are supported through multiple different services, the different services may be offered/implemented by a same service module, different service modules, or a combination wherein one or more service modules may offer a subset of multiple services. In some embodiments, at least some of the multiple tasks are identical. In some embodiments, when the mission includes multiple sub-missions, some of the multiple sub-missions may be identical. In some embodiments, all of the multiple tasks are different.

A mission slice associated with a mission includes one or multiple BB slices, each being associated with a BB of the mission. Such a BB slice is a task slice if the respective BB is a task, and a sub-mission slice if the corresponding BB is a sub-mission. The sub-mission slice is a mission slice associated with another mission that corresponds the sub-submission.

When a mission is executed over a mission slice associated with the mission, BB(s) of the mission are executed over their corresponding BB slice(s) in the mission slice with respect to a mission graph (workflow) that specifies execution dependency, ordering or sequence, timing between the BB(s).

A mission may include one or multiple access points (a.k.a. participation points), each corresponding to a BB of the mission. A network entity can access (in other words, contribute to, participate in) an execution of a mission via the one or multiple access points, i.e. by accessing execution(s) of corresponding BB(s) within the execution of the mission. A network entity that interacts with a mission as described above is referred to as a mission participant.

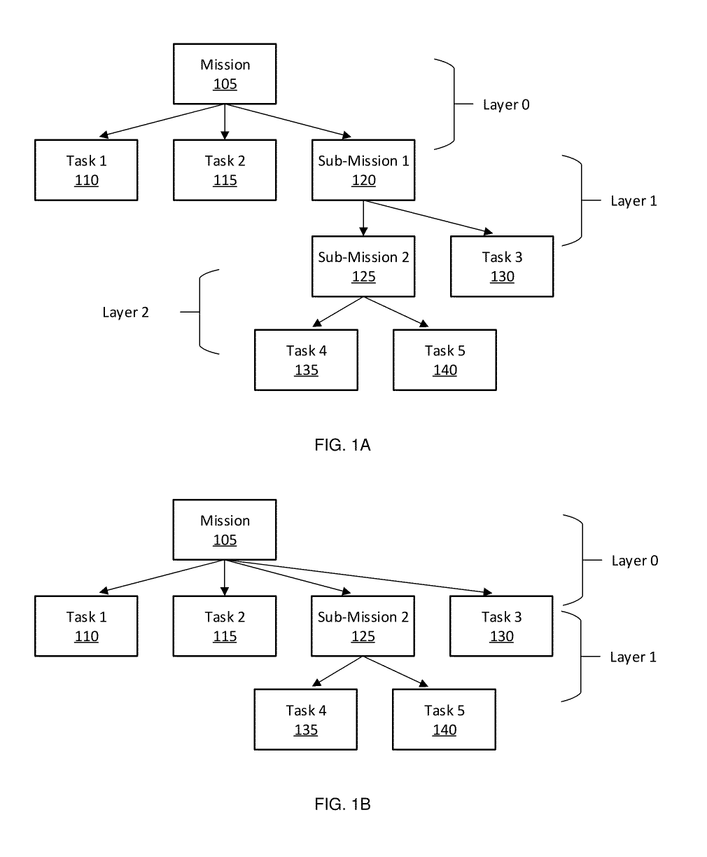

Referring to FIG. 1A, an illustrative embodiment of a simplified schematic of a mission hierarchy is presented. The illustrative hierarchy of FIG. 1A is used throughout this disclosure as an example to explain the concepts described herein. In the illustrative embodiment of FIG. 1A, a mission 105 includes three BBs: task 1 110, task 2 115, and sub-mission 1 120. The sub-mission 1 120 includes its own BBs, sub-mission 2 125 and task 3 130. Sub-mission 2 125, in turn, includes its own BBs: task 4 135 and task 5 140.

The inclusion of the BBs under the mission 105 may happen in layers, i.e. layer 0, layer 1, and layer 2 as indicated in FIG. 1A, which leads to a mission hierarchy. In the embodiment of FIG. 1A, the mission 105 and its 3 BBs (task 1 110, task 2 115, and sub-mission 1 120) form layer 0. Since neither task 1 110 nor task 2 115 include additional BBs, they only reside as part of layer 0. Sub-mission 1 120, however, includes two BBs (sub-mission 2 125 and task 3 130) which form layer 1 in the hierarchy. Sub-mission 2 125 in turn includes an additional 2 BBs (task 4 135 and task 5 140) which make up layer 2 in the hierarchy.

Sub-mission 1 120 may be referred to as reusable since it can be embedded or included in mission 105 as a BB of mission 105. In other words, mission 105 is re-using sub-mission 1 120. In general, a reusable mission, such as sub-mission 1 120 may be reused either in an exclusive reuse mode or in a shareable reuse mode. If sub-mission 1 120 is being reused by mission 105 in an exclusive reuse mode, then sub-mission 1 120 can be unfolded within mission 105 such that mission 105 includes BBs of sub-mission 1 120 directly. If sub-mission 1 120 in mission 105 is in the sharable mode, then sub-mission 1 120 should not be unfolded within mission 105.

As illustrated in FIG. 1A, mission 105 is shown as including multiple tasks as BBs. Accordingly, these tasks may be supported by a same service or by different services, and the different services may be offered/implemented by a same service module or by different service modules. While multiple tasks and sub-missions may be identical, for the purposes of the illustrated example, we assume that the tasks and sub-missions of mission 105 are different since they are differentiated in FIG. 1A.

As explained above, a sub-mission, such as sub-mission 1 120 in FIG. 1A, may include its own BBs (i.e. task 3 130, and sub-mission 2 125). Furthermore, a BB that is a sub-mission, such as sub-mission 2 125, may include its own BBs. The inclusion of these BBs may create layers within mission 105, leading to a mission hierarchy such as the one illustrated in FIG. 1A. In order to simplify the structure or hierarchy of a mission, such as mission 105, it may be convenient to unfold or “roll-up” layers of one or more sub-missions included in the mission.

FIG. 1B is an illustrative embodiment of the simplified schematic of a mission hierarchy from FIG. 1A after sub-mission unfolding. In the embodiment of FIG. 1B, it is assumed that the sub-mission 1 120 FIG. 1A is a reusable mission in the exclusive reuse mode, and accordingly sub-mission 1 120 may be unfolded within the mission 105. FIG. 1B shows the mission hierarchy after unfolding sub-mission 1 120, wherein task 3 130 and sub-mission 2 125 are directly included in the mission 105 as part of layer 0. Note that if the sub-mission 2 125 is also in the exclusive reuse mode the hierarchy may be further simplified by also unfolding sub-mission 2 125 to bring task 4 135 and task 5 140 into layer 0. Unfolding a sub-mission leads to reduced mission hierarchy and can therefore lower mission management overhead.

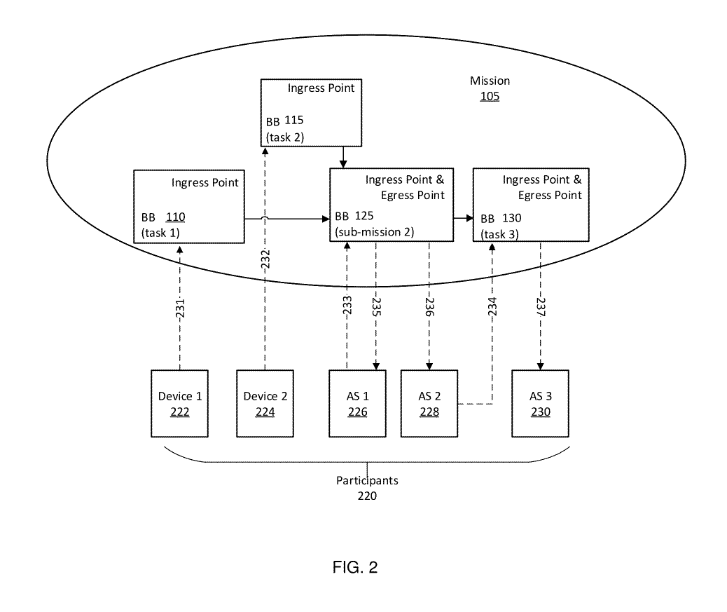

Referring to FIG. 2, an illustrative embodiment of a simplified schematic of a mission graph is presented. The mission graph of FIG. 2 based on the example of FIG. 1B. As described above, a mission 105 includes one or multiple BBs (110, 115, 125, 130), and the mission 105 is associated with a goal. The goal of the mission 105 is related to goals of the one or multiple BBs (110, 115, 125, 130) of the mission 105 and, in some embodiments, is more complicated than the goal of an individual BB (215a, 215b, 215c, or 215d) of the mission 105. The goal of the mission 105 can be achieved or accomplished through an execution of the mission 105, wherein the one or multiple BBs (110, 115, 125, 130) are executed with respect to a workflow associated with the mission 105. Thus, the execution of the mission 105 includes an execution of each BB (110, 115, 125, 130) of that mission 105.

The workflow associated with a mission 105 is referred to as a mission workflow or mission graph of mission 105. The mission graph describes dependency, timing and/or ordering between the one or multiple BBs (110, 115, 125, 130) of the mission 105. The dependency, timing and/or ordering indicate the order of execution for the one or multiple BBs (110, 115, 125, 130) in order to achieve the goal of the mission 105.

If the mission workflow describes that a first BB precedes a second BB, for instance if the second BB depends upon an output or result derived from the first BB, then the mission workflow will indicate that the second BB should be executed after the first BB has been executed. In some cases, the second BB execution will occur after, or as a result of, an output or result from the first BB. In these cases, mission resources can be allocated to the first BB and the second BB sequentially, in the specified order, in order to achieve the mission goal. The mission resources may include network resources such as bandwidth and spectrum, network functions such as TCF and PSF, and computing resources (such as CPU cycle, I/O access, memory, storage) associated with the network functions. Furthermore, the mission resources must be allocated such that the second BB receives a result of execution of the first BB as may be required for the second BBs dependency upon the first BB.

On the other hand, if the mission workflow describes that a first BB and a second BB depend upon one other, the mission workflow will indicate that the first BB and the second BB should be executed in parallel (i.e. at the same time). In this case, mission resources can be allocated to both the first BB and the second BB at the same time in order to achieve the mission goal. Furthermore, mission resources must be allocated such that the first BB and the second BB are operative to interact with one another during execution to exchange information during operation.

If the mission workflow describes that there is no dependency or ordering between a first BB and a second BB, then the mission workflow will indicate that the first BB and the second BB may be executed at the same time but may not require parallel execution. In this case mission resources need not be allocated to the first BB and the second BB at the same time in order to achieve the mission goal. Furthermore, mission resources need not be allocated to coordinate the exchange of information or results between the first BB and the second BB.

In the mission graph of FIG. 2, solid arrowed lines indicate dependency between BBs. For example, if two BBs 110, 115 (e.g. task 1 and task 2) are not linked by a solid arrowed line, there will not be a dependency between the two BBs 110, 115. If, as indicated, two BBs 110, 125 (e.g. task 1 and sub-mission 1) are linked by a solid arrowed line, there will be a dependency between the two BBs 110 and 125, and the depending BB pointed to by the arrowed line, e.g. sub-mission 1 125 where the arrowed line terminates, will depend on the originating BB, e.g. task 1 110 from which the arrowed line originates.

In the embodiment of FIG. 2, device 1 222 and device 2 224 are data sources for the mission 105. AS 1 226 and AS 2 228 are both a data source and a data destination. AS 3 230 is only a data destination for the mission 105.

BBs are implemented as BB slices which include the relevant network entities (i.e. allocated mission resources). The mission 105 may be implemented as a mission slice having one or multiple access points (a.k.a. participation points), each of which corresponds to a BB slice of the mission slice corresponding to the mission 105. A BB slice may operate as an access point of a mission slice. The access point may be an ingress access point, an egress access point, or an ingress & egress access point. It may also be possible for a BB slice to support multiple access points, and ingress and egress may be denoted by separate access points if desired. For the purposes of clarity, this disclosure has simplified to including a single access point for each BB slice, and the functionality of each access point may be ingress, egress, or both ingress & egress. From a practical perspective multiple access points for a BB slice may be useful for differentiating between ingress and egress, or where the BB slice is interacting with multiple other BB slices or mission participants and it would be useful to distinguish between access or access rights between the participants or other BB slices. Accordingly, a BB slice may act as at least one access point, and the at least one access point may include one or more rights of access depending upon the requirements of a mission or a need to distinguish between the access.

When a mission 105 is executed over a mission slice, with respect to the mission workflow, for achieving the goal of the mission 105, a network entity, referred to as a mission participant or simply a participant 220, can access, in other words, participate in or contribute to the execution of the mission 105 (i.e. the mission execution) via an access point which is a BB slice of the mission 105. The mission participant 220 may access the mission execution via multiple access points, i.e. multiple BB slices, of the mission 105, sequentially or at the same time. The mission participant 220 may be a variety of network entities, including for instance a device 222224 (e.g. a user equipment (UE), a server (e.g. application server 226, 228, 230), a network function, or other relevant network entity. In the embodiment of FIG. 2, Device 1 222 and Device 2 224 are solely data sources. As illustrated, AS 1 226 and AS 2 228 are both a data source and a data destination while AS 3 230 is solely a data destination.

During execution of the mission 105 over a mission slice, the one or multiple BBs 110, 115, 125, and 130 of the mission 105, are executed over corresponding BB slices. Thus, the execution of the mission 105 includes, or is associated with the corresponding execution of each BB 110, 115, 125, 130 of the mission 105. When the mission participant 220 accesses the mission execution via an access point of the mission 105, the mission participant 220 actually accesses an execution of the access point, i.e. a BB slice. The BB slice being part of/associated with the mission slice.

When accessing the mission execution via an access point of the mission slice, the mission participant 220 can act as a data source, a data destination, or both. If the mission participant 220 acts as a data source during the access, the mission participant 220 sends or provides data to the access point to support the execution of the BB over the BB slice and thus the execution of the mission 105. In this case, the BB slice is an ingress point of the mission slice, operative to receive data from one or more mission participants 220. If the mission participant 220 acts as a data destination during the access, the mission participant 220 receives or obtains data from the access point related to the execution of the BB over the BB slice and thus the execution of the mission 105. In this case, the BB slice is an egress point of the mission slice, operative to deliver data to one or more mission participants 220. As mentioned above, and differing from the example in FIG. 2, it may be more convenient to separate the ingress and egress operations into separate access points depending upon requirements to differentiate between the different access operations.

An access point of the mission slice may be both an ingress point and an egress point of the mission slice. In other words, ingress to and egress from a mission slice may be provided by a same access point of the mission slice. In some embodiments, it is pre-determined or pre-configured whether an access point is an ingress point, an egress point, or both an ingress point and an egress point. In some embodiments, a mission participant 220, when acting as a data source, is allowed to access a mission slice only through an ingress point of the mission slice, and when acting as a data destination, only through an egress point of the mission slice.

In FIG. 3, all of the building block slices 310, 315, 325, 330 are access points of the mission slice 305. Each of these access points can receive input data from at least one participant 220 through connections, as indicated in FIG. 3 by solid arrowed lines 331. 332, 333, 334, 336, 337, extending between the participants 220 and the border PFs 307. Accordingly, in FIG. 3 the recipient BB slices 310, 315, 325, 330 provide ingress points for the mission slice 305.

In FIG. 3, two of the BB slices, sub-mission slice 2325 and task slice 3 330, are operative to transmit output data to at least one participant 220 through connections, as indicated in FIG. 3 by solid arrowed lines 333, 336, 337. The ability to transmit output data is illustrated in FIG. 3 by the arrowed lines originating from a border PF 307 within the BB slice and terminating at mission participants 226, 228, and 230.

In some embodiments, a mission and its workflow may be pre-configured. In some embodiments, a mission may be dynamically created by a network function, such as an Application Function (AF) or a Service Control Function (SCF). In either case, the mission is described using mission information which characterizes the structure and operation of the mission. The mission information may conveniently be stored in a network function, such as a mission data repository (MDR) described below with reference to FIG. 4.

The mission information may include any of the following information depending upon network and/or mission requirements: i) mission identifying information; ii) validity conditions; iii) reusability indication; participant information; iv) interface information; v) mission intent; or, vi) mission specification.

The mission identifying information, such as for instance a mission ID or mission name, may be used to identify the mission and/or distinguish the mission from other missions.

The validity conditions define (describes or specifies) where and/or under what circumstances the mission may be executed. An example of a validity condition would be a spatial validity condition. A spatial validity condition describes where the mission can be executed. In some embodiments, the spatial validity condition may be expressed by a list of zone IDs, each of which may identify or be mapped to a geographic zone/area of the network. In some embodiments, the list of zone IDs may include RAN node IDs or cell IDs. In some embodiments, the spatial validity condition may identify or be mapped to a logical zone/area within the network. Depending upon the network topology, a spatial validity condition may also identify or be mapped to a combination of geographic zones/areas and/or logical zones/areas of the network. Another example of a validity condition is a temporal validity condition. A temporal validity condition describes when (e.g. in terms of time) the mission can be executed. It may be expressed by one or multiple time-intervals or durations, each being associated with a start time and in some embodiments with an end time too. A validity condition may further include a dependence upon another condition or state. For instance, a temporal validity condition may depend upon occurrence of another event, such as a resource allocation or a condition being true, before the time component is triggered.

The reusability indication indicates whether or not the mission is reusable. If the mission is reusable, the indication may further indicate how the reusable mission should be reused, for example by indicating a reuse mode. In some embodiments, the reusability indication and/or the reuse mode may further include a condition for reuse. In these embodiments the reusable mission may only be reused if the condition for reuse is met. For example, a reuse mode may be an exclusive mode or a sharable reuse mode. If the reuse mode is the exclusive reuse mode, it means that an instance of the reusable mission should be embedded/included in at most one mission instance, which is an instance of another mission that reuses the reusable mission. If the reuse mode is the sharable reuse mode, it means that an instance of the reusable mission can be embedded/included in multiple mission instances, each being an instance of another mission that reuses the reusable mission. A mission instance may be referred to as a mission slice, as described above and further below with reference to FIG. 3.

The participant information identifies the mission participant(s) in the mission. The participant information may include mission participant identifier(s), for instance, the ID(s), name(s) or network address(es), of the mission participant(s). Each mission participant identifier identifies a mission participant of the mission. The participant information may further include a list of group ID(s) or name(s) that identifies group(s) of mission participant(s), or other identifying information that identifies each member of a group of mission participant(s). In some embodiments, for instance, the participant information may be presented as a list of mission participant identifier(s) for each group of mission participant(s). In other embodiments, for instance, the participant information may be presented as a list of mission participant group(s), each group including one or more mission participants assigned to that group.

The participant information may further include, for instance, for each identified mission participant, information indicating whether the mission participant is a data source, data destination, or both a data source and a data destination of the mission. A mission participant identified in this information may be a device, a server (e.g. an application server (AS)), a network function, or other network entity that is involved in the mission.

In some embodiments, the participant information may further include location information identifying location or potential location of the mission participant(s). This location information may identify a location or potential location of the data sources, and/or location or potential location of the data destination(s). In some embodiments, the location(s) or potential location(s) identified in the location information may be expressed by area/zone ID(s). In some embodiments, the location(s) or potential location(s) identified in the location information may each be expressed by a network address or other network location information (e.g. a DNAI (data network access identifier), a DNN (data network name)).

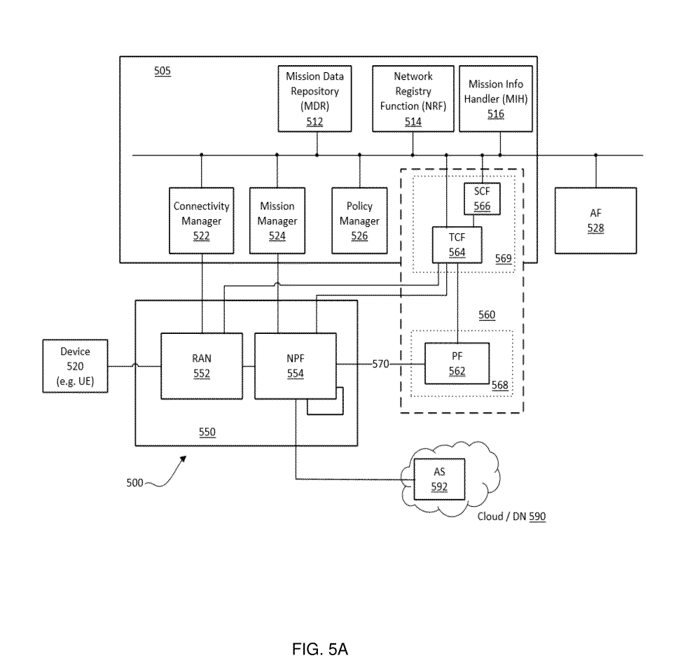

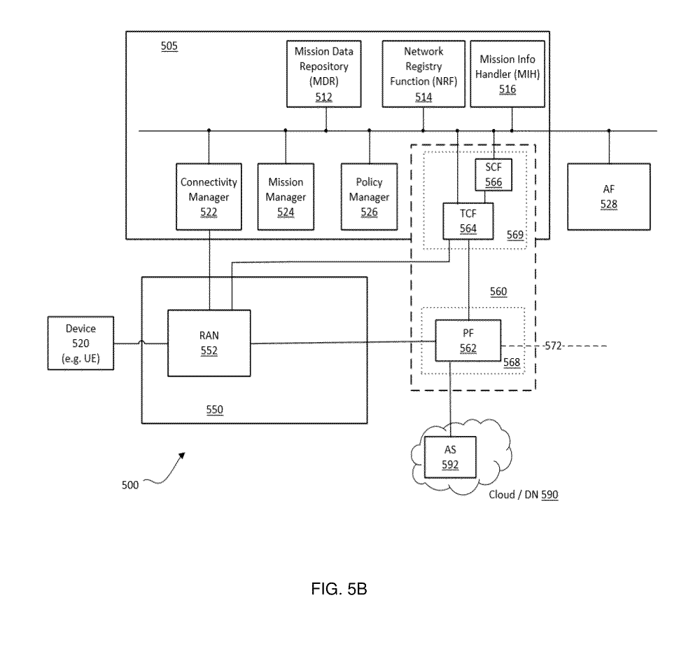

The interface information provides the potential details for one or multiple interfaces between mission participants and the communication system for the mission. An embodiment of a system architecture illustrating mission interfaces is illustrated in FIG. 5A, and discussed below. The potential one or multiple interfaces include inbound interface(s) and/or outbound interface(s). The interface information specifies or indicates, for each of the one or multiple interfaces, whether the interface is an inbound interface or an outbound interface and that it is accessible and relevant to the mission. The interface information may further indicate which mission participants may interact with that interface and/or whether the interaction is inbound and/or outbound. An inbound interface may also be referred to as an ingress interface. An outbound interface may also be referred to as an egress interface.

In some embodiments, the one or multiple interfaces may each be in the form of an application programming interface (API) or a service based interface (SBI). Each of the one or multiple interfaces can be used through a remote procedure call (RPC).

The inbound interface(s) are to be implemented/supported by the mission participants 220 and are offered to the communication system to use/call. During an execution of the mission 105, one, or more than one, network entity in the system, e.g. the processing functions (PFs) in FIG. 4, may call the inbound interface(s) and thus interact with the mission participant(s). The interaction may include, for instance, the network entities (PFs) providing data to, or obtaining data from the mission participants) 220.

The outbound interface(s) are implemented/supported by the system (i.e. one or more than one network entities in the system, e.g. the PFs in the FIG. 4) and are offered to the mission participant(s) 220 to use/call. During an execution of the mission 105, a mission participant 220 may call the outbound interface(s) and thus interact with the system by interacting with the one or more than one network entities implementing/supporting the interface(s) in the system (e.g. providing data to, or obtaining data from the one or more than one network entities).

The interface information specifies, for each of the one or multiple interfaces, a name or ID of the interface, a list of input parameter(s) of the interface, and a list of return value(s) (i.e. result(s)) of the interface. When specifying an input parameter, the interface information specifies the name or ID of the parameter and the type (e.g. string, integer, float, binary, octal, hexadecimal) of the parameter. When specifying a return value, the interface information specifies the name or ID of the value, the purpose of the value and the type of the value (e.g. string, integer, float, binary, octal, hexadecimal). The interface information further specifies or indicates, for each of the one or multiple interfaces, whether the interface is an inbound interface or an outbound interface (in other words, whether the interface is to implemented/supported by a mission participant or available in the system for a mission participant to use/call.

The interface information may further specify or indicate which of the interfaces may be associated with which mission participant(s) 220. More generally, the interface information may specify or indicate what type (e.g. data source or data destination) of mission participant(s) 220 is eligible to be associated with each interface. For example, this information may specify which of the one or multiple interfaces are associated with a data source, and which of the one or multiple interfaces are associated with a data destination. The participant information specifies whether a mission participant 220 is a data source or a data destination, as described above. By matching eligibility of a mission participant 220 to be associated with a particular interface, and whether or not the mission participant 220 is a data source or a data destination, the mission participants 220 may interoperate with the interfaces of a mission 105. In particular, based on the interface information and the participant information, a mission participant 220 should be operative to implement/support any inbound interface(s) associated with it, and to use/call any outbound interface(s) associated with it.

In some embodiments, the one or multiple interfaces are described in terms of data types. In this case, the inbound interface(s) corresponds to type(s) of input data, which is provided from the mission participants 220 to the system, while outbound interface(s) corresponds to type(s) of output data, which is provided from the system to the mission participants 220. The interface information comprises input data information (i.e. information about the inbound interface(s)) and output data information (i.e. information about the outbound interface(s)).

The input data information may include input data type information for at least some of the data source(s) identified in the participant information. The output data information may include output data type information for at least some of the data destination(s) receiving data from the system. In general, data type information (e.g. the input data type information or the output data type information) describes or indicates type(s) of data that an entity may provide or receive. The data type information may be provided, for instance, in the form of a list of data attribute name(s)/ID(s), or one or multiple data type ID(s). In some embodiments, each of the one or multiple data type ID(s) is mapped to a list of data attribute name(s)/ID(s).

The mission intent information describes a target service and a mission goal, both being associated with the mission. The goal described in the mission intent information is the goal of the mission described above. In some embodiments, if a mission specification is present in the mission information and if the mission is not reusable as indicated in the reusability indication, the mission intent may be optional. The mission intent information includes target service information and mission goal information.

The mission is supported by one or multiple services, one of which is the primary supporting service of the mission and referred to as a target service. The target service information identifies the target service. The target service information may be in the form, for instance, of a service ID or name of the target service. The target service information can be used to select a service control function (SCF), as described in the embodiment associated with FIG. 5A.

The mission goal information describes a goal that the mission is associated with, i.e. the goal of the mission. It includes application category information and service problem information. The application category(ies) and the service problem(s) that are identified in the mission goal information are associated with the target service identified in the target service information.

The application category information identifies one or multiple application categories that the mission is related to. The application category information may be, for instance, in the form of a list of application category ID(s).

The service problem information identifies one or multiple service problems that the mission relates to in order to achieve the goal. A service problem identified in the service problem information may be related to communication, data processing, or both. The service problem is associated with a service offered by a service module and may be used to describe a goal of a task, as described below with respect to FIG. 4. The service problem information may be in the form, for instance, of a list of problem ID(s). The service problem information may be per application category as identified in the application category information. In addition to identifying service problems, the service problem information may further include a weight value for some or all of the service problems. The weight value indicating a weight of the service problem in the goal of the mission (i.e. how important the problem is to the goal of the mission). The service problem information may be used when assigning resources to address the service problems.

The mission specification is an optional component of the mission information. A mission specification describes a networking procedure related to a corresponding mission. In particular, the mission specification specifies how one or more BB(s) of the mission interact with each other, and/or with mission participants to achieve the goal of the mission (i.e. the mission goal). When included, the mission specification includes composition information, workflow information, and access point information.

The composition information identifies the BB(s) of the mission and specifies/describes interconnection(s) between the BB(s). A BB (building block) is a task or a sub-mission, as described earlier. The composition information may include information identifying tasks, sub-missions of the mission and/or interconnections between the tasks and/or sub-missions of the mission.

The composition information may include task identifying information that identifies one or multiple tasks in the mission, e.g. one or multiple task IDs, and for each identified task, task information. The one or multiple tasks identified in the composition information are BBs of the mission. The task identifying information is optional if the mission does not include any tasks and is described below in more detail with reference to FIG. 4.

The composition information may include sub-mission identifying information that identifies one or multiple sub-missions in the mission and corresponding reusable mission(s). A sub-mission may be identified by a sub-mission ID, a reusable mission corresponding to the sub-mission may be identified by a mission ID. The one or multiple sub-missions are BBs of the mission. The sub-mission identifying information is optional if the mission does not include any sub-missions.

The composition information may include interconnection information that identifies or specifies any interconnection(s) between the BBs of the mission. The interconnection information relates to the one or multiple tasks identified in the task identifying information and/or the one or multiple sub-missions identified in the sub-mission identifying information. The interconnection information may specify or describe which BB (e.g. identified by a first BB ID) of the mission interconnects with which other BB (e.g. identified by a second BB ID) of the mission through which interface(s). The BB IDs may, for instance, be a task ID provided in the task identifying information or a sub-mission ID provided in the sub-mission identifying information. The interconnection information may further specify or describe interface(s) interconnecting the BBs of the mission. In some embodiments, such an interface is in the form of SBI(s) or API(s), and the interconnection information may identify the SBI(s) or API(s) and, in some aspects, may further specify or describe which BB provides (or implements) which SBI(s) or API(s) and which BB calls which of those SBI(s) or API(s). Note that a first BB calling an SBI or API provided by a second BB is considered interconnected with the second BB. In some embodiments, such an interface is described in terms of data type(s), and the interconnection information may specify or describe the interface by specifying which BB provides what type of data (e.g. identified by a data type ID) to which other BB. The interconnection information is optionally included in the composition information.

The workflow information describes or specifies ordering or timing between the BBs identified in the composition information. The workflow information may indicate BB dependency, i.e. which BB(s) identified in the composition information depend on which other BB(s) identified in the composition information. In some embodiments, the workflow information indicates which BB(s) identified in the composition information proceed or follow other BB(s) identified in the composition information. In some embodiments, the workflow information indicates, for at least one BB, temporal conditions related to execution of that building block, i.e. when in terms of time or triggering conditions a BB identified in the composition information should be executed. The workflow information is optional.

The access point information describes or specifies any access points of the mission. In some embodiments, for instance, the access point information may identify which BBs are access points by including of a list of BB identifiers. The access point information may further indicate the type of access point. For instance, access point information may identify which BBs are access points and whether they are an ingress point, egress point, or both an ingress and egress point. In some embodiments, for instance, the access point information may be in the form of a list of BB identifiers that are ingress points and a list of BB identifiers that are egress points. In other embodiments, the access point information may be in the form of a list of BB identifiers, each associated with an access point type such as ingress, egress and/or ingress/egress type.

Referring to FIG. 3, an illustrative embodiment of a simplified schematic of a mission slice, a mission 105 may be executed over a mission slice 305 that is associated with the mission 105. Components in FIG. 3 relate back to the hierarchy introduced in FIG. 1B and FIG. 2.

The mission slice 305 is related to or associated with an application. When the mission 105 is executed over the mission slice 305, the mission 105 is executed for the application (or in other words, to serve the application). The mission 105 can be executed multiple times over the mission slice 305. The mission slice 305 is also referred to as an instance of the mission 105 (or simply a mission instance). Information identifying the mission slice 305 is referred to as a mission slice ID (or mission instance ID). In some embodiments, the mission slice 305 is identified by information identifying the mission 105 (i.e. mission identifying information) and the information identifying the application (i.e. application identifying information). In these embodiments, the mission slice ID comprises the mission identifying information and the application identifying information.

In the example of FIG. 3, the mission slice 305 includes task slices 310, 315, 330 (described in more detail below in reference to FIG. 4) and sub-mission slice 2 325. Each of the task slices 310, 315, 330 corresponds to a task of the mission 105. Sub-mission slice 325 is a mission slice corresponding to a sub-mission of the mission 105. The task slices 310, 315, 330 and the sub-mission slice 2 325 are collectively referred to as building block (BB) slices for ease of presentation.

In FIG. 3, a mission slice 305 is associated with a mission 105 and includes four BB slices: task slice 1 310, task slice 2 315, task slice 3 330, and sub-mission slice 2 325. The four BB slices relate back to task 1 110, task 2 115, task 3 130, and sub-mission 2 125 of the mission 105 illustrated in FIG. 1B and FIG. 2. Note that sub-mission slice 2 325 as a mission slice has its own BB slices, i.e. relating BB slices that relate to task 4 135 and task 5 140 in FIG. 1B, though they are not shown in the layer illustrated in FIG. 3.

Mission participants 220, e.g. device 1 222, may access the mission 105 (more precisely, an execution of the mission 105) by accessing an execution of an access point of the mission 105, for instance task 1 110, the execution of the access point being part of the mission execution. To access the execution of the access point, a mission participant 220 is connected (attached) to a BB slice in the mission slice 305, the BB slice corresponding to the access point of the mission 105, through a border PF 307 of the BB slice. For example, device 1 222 is attached to a border PF 307 of task slice 1 310 in FIG. 3.

In some embodiments, a mission participant may access the mission 105 via multiple access points of the mission. For example, as illustrated in FIG. 2, AS 2 228 can access the mission 105 via the sub-mission 2 125 and via the task 3 130. Accordingly with reference to FIG. 3, in this example, the mission participant 228 is connected to a border PF of a first BB slice (e.g. sub-mission slice 2 325) corresponding to the first access point and a second border PF of a second BB slice (e.g. task slice 3 330) corresponding to the second access point in the mission slice 305.

When a mission participant 220 is connected (or attached) to a BB slice in the mission slice 305, the mission participant 220 is connected to at least one border PF of the BB slice. The border PF is in the data plane of that BB slice. If the mission participant 220 acts as a data source, the at least one border PF may include one or multiple ingress PFs of the BB slice, and the mission participant 220 sends/provides data to the one or multiple ingress PFs during mission execution. If the mission participant 220 acts as a data destination, the at least one border PF includes one or multiple egress PFs of the BB slice, and the mission participant 220 receives or obtains data from the one or multiple egress PFs during mission execution.

If BBs in the mission are interconnected as described in the composition information in the mission specification, then corresponding BB slices for each of the BBs are interconnected in the mission slice. In general, an access point such as an egress PF in a first BB slice may be connected to an ingress PF in a second BB slice via one or multiple communication tunnels. Alternatively, an ingress PF in a first BB slice may be connected to an egress PF in a second BB slice. The interconnection(s) are referred to as intra-mission connection(s) and may be supported by communication tunnel(s). Referring to FIG. 2, for instance, task 1 110 and sub-mission 2 125 are shown as having interconnections in the mission 105. Accordingly, corresponding task slice 1 310 and sub-mission slice 2 325 are interconnected in the mission slice 305, as illustrated un FIG. 3. The intra-mission connections are shown as dashed lines connecting the border PFs 307 of the BB slices.

In some embodiments, the intra-mission connection(s) are considered part of the mission slice 305. During mission execution, BB slices may communicate with each other through the intra-mission connection(s) which arise as part of mission execution.

The mission slice 305 is described by mission slice information that may include task slice information corresponding to each task in the mission, sub-mission slice information corresponding to each sub-mission in the mission, and intra-mission connection information corresponding to each intra-mission connection.

A service is offered by a service module to solve at least one problem, which may be referred to as service problem and is associated with that service. A service problem may be used to describe a goal of a mission (as described in more detail above in relation to mission information) and/or a goal of a task (as described in more detail below with reference to task information). Examples of service problems may include, for instance, problems related to communication and/or data processing in order to achieve the goal. Solving such a service problem may include, for instance, communicating with one or multiple PFs in the service module, the PFs in the service module processing data traffic, and coordinating, e.g. by a task control function (TCF) in the service module, the communicating and data processing. The service module may offer or support more than one service, each or which may be associated with its own set of service problems.

Referring to FIG. 4, an illustrative embodiment of a simplified schematic of a service module, a service module 400 may include a service control plane (SCP) 405 and a service data plane (SDP) 410. The SDP 410 of the service module 400 may include one or multiple PFs 434, 436, 438, 440, 442. The SCP 405 of the service module 400 may include one or multiple service module controllers (SMCs) such as service control functions (SCF) 420, 422 or TCF 424, 426, 428.

The service offered by the service module may support one or multiple tasks. A task (e.g. task 1 110, task 2 115, task 3 130) is a building block (BB) of a mission 105 that is associated with a goal of the task, i.e. a task goal, and is related to at least one of the service problem(s) associated with the service.

When a mission is executed, tasks may be executed as part of the mission with the intent to achieve the goal of each task. Achieving the task goals support achieving the goal of the mission. The mission is executed over a mission slice, and the tasks are executed over corresponding task slices supporting each task. The task slices are included as part of the mission slice. During execution of a task, network entities that are not part of the task slice may access, contribute to, or participate in the task execution. For instance, data sources may provide input data to support the task execution and/or data destinations may receive output data that is a result of the task execution. A network entity that interacts with a task is referred to as task participant. The network entity may be a mission participant 220, i.e. a device or AS, or may be a network function (e.g. a PF in a different task slice in the mission slice). For example, in FIG. 3, task slice 1 310 interacts with sub-mission slice 2 325. Accordingly, PFs in sub-mission slice 2 325 may be task participants for task slice 1 310. As described in relation to FIGS. 2 and 3 above, a network entity may act both as a data source or as a destination for the mission 105 and/or for a particular task 110, 115, 130.

A task participant may be a participant of the mission 105. For instance, when the task is an access point of the mission 105 and when a mission participant 220 accesses the execution of the mission 105 via the execution of the task, such as device 1 222 connecting to task slice 1 310 in support of the mission 105. In this case, achieving the goal of the task is equivalent to solving at least one service problem associated with the service, using data provided by task participants, in this case device 1 222.

A service may be identified by a servicer identifier, such as a service ID or service name. Each of the one or multiple tasks associated with the service may be identified by a task identifier, such as a task ID or a task name. In some embodiments, the task identifier may also include the service identifier associated with that task. In some embodiments, when a service supports only one task, the service and the task may be considered to be equivalent and accordingly may be identified or referred to by a same identifier – i.e. the service identifier and the task identifier comprise the same identifier.

A task belongs to or is part of at least one mission and supported by a service that is associated with at least one service problem. The task is associated with a goal, the task goal, which is useful to execute to achieve a mission goal. In some embodiments, a task may be configured by a network function in the management plane. In some embodiments, the task is dynamically created by a network function (e.g. an AF or an SCF). In either case, the task may be described using task information which may conveniently be stored in a network function such as a mission data repository (MDR).

The task information may include some or all the following information: mission identifying information, task identifying information, service identifying information, task goal information, and/or interface information. The mission identifying information identifies the at least one mission, for instance through a list of mission ID(s) or a list of mission name(s). The task identifying information identifies a task, for instance through a task ID or a task name. The service identifying information identifies the service, for instance through a service ID or a service name.

The task goal may be identified by the task goal information that describes the goal(s) of the task. The task goal information may include, for instance, a list of problem identifiers, i.e. problem ID(s), that each identify a service problem. The service problems identified in the task goal information are part of the set of service problems associated with the service and related to the task goal. For each of the identified service problem(s), this information (i.e. the task goal information) may further include a weight value. The weight value indicates a weight of that service problem in the goal of the task (i.e. how important the service problem is to the goal of the task). The weight value may be evaluated, for instance, when assigning resources to address the task goal.

The interface information describes one or multiple interfaces between the task and task participants (e.g. PFs, devices, application servers). The one or multiple interfaces may include inbound interface(s) and/or outbound interface(s). The interface information may specify or indicate, for each of the one or multiple interfaces, whether the interface is an inbound interface or an outbound interface. In some embodiments, the one or multiple interfaces are in the form of API(s) or SBI(s). Each of the one or multiple interfaces can be used through a remote procedure call (RPC).

The inbound interface(s) are implemented/supported by the task participants and are offered to the task to use/call. During an execution of the task over the task slice, one or multiple PFs in a task slice 402 of the task (e.g. PF2 434, PF3 436 in FIG. 4) may call the inbound interface(s) and thus interact with the task participants (e.g. providing data to, or obtaining data from the task participants).

The outbound interface(s) are implemented/supported by the task (i.e. one or more than one PF in a task slice 402 of the task, e.g. PF6 442 in FIG. 4) and are offered to the task participants to use/call. During an execution of the task over the task slice, the task participants call the outbound interface(s) and thus interact with the task, in essence, with the one or more than one PF implementing/supporting the interface(s) in the task slice (e.g. providing data to, or obtaining data from the PF).

The interface information may specify, for each of the one or multiple interfaces, a name or ID of the interface, a list of input parameter(s) of the interface, and a list of return value(s) (in other words, result(s)) of the interface. When specifying an input parameter, this information specifies the name of the parameter and the type (e.g. string, integer, float, binary, octal, hexadecimal) of the parameter. When specifying a return value, this information specifies the name or ID of the value, the purpose of the value and the type (e.g. string, integer, float, binary, octal, hexadecimal) of the value.

The interface information may further specify or indicate which of the interfaces are associated with which each type of task participant (e.g. data source or data destination). Task participants are assigned a task participant type to ensure that they are operative to implement/support any inbound interface and/or use/call any outbound interface associated with that task participant type.

In some embodiments, an interface may be described in terms of data types. In this case, an inbound interface may correspond to one or more types of input data which may be identified and/or provided from the task participants to the task. Similarly, an outbound interface may correspond to one or more types of output data which may be identified and/or provided from the task to the task participants. The interface information includes both the inbound interface information (i.e. information about the inbound interfaces such as an input data type) and the outbound interface information (i.e. information about the outbound interfaces such as an output data type).

The input data information describes or indicates one or multiple types of input data (i.e. data provided to or received by the task), e.g. by including a list of data type ID(s). For each of one or multiple data types, this information may further describe or indicate one or multiple data formats that are supported by the task, e.g. by including a list of data format ID(s). In some embodiments, the list of data format ID(s) is(are) optional when the list is pre-determined or pre-configured for the data type.

The output data information describes or indicates one or multiple types of output data (i.e. data provided by or transmitted from the task), e.g. by including a list of data type ID(s). For each of one or multiple data types, this information may further describe or indicate one or multiple data formats that are supported by the task, by including a list of data format ID(s). In some embodiments, the list of data format ID(s) is(are) optional when the list is pre-determined or pre-configured for the data type.

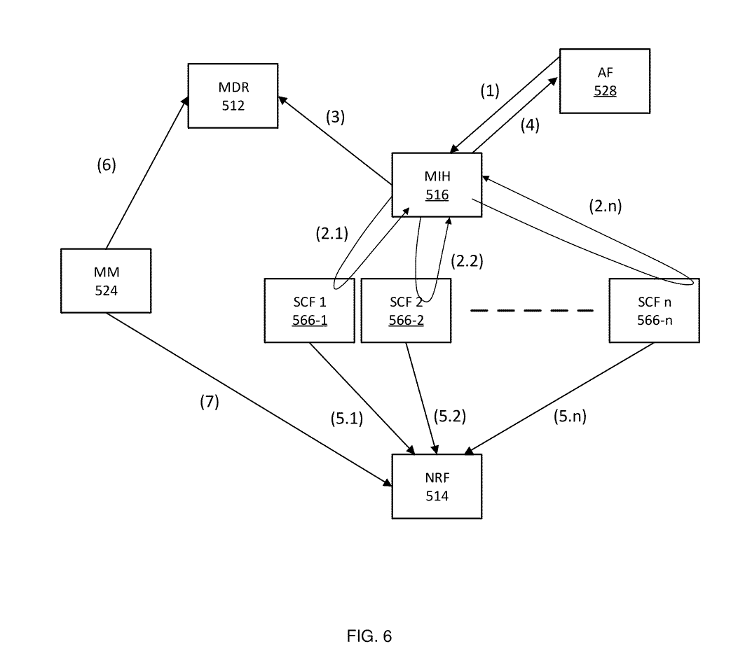

A task, such as the task described above, is executable over a corresponding task slice. A task slice may be established by an SCF in the SCP, such as is described below in the embodiment associated with FIG. 6. The goal of the task is achieved when, or as a result of, the task is executed over the task slice which includes a task control plane and a task data plane. The task can be executed over the task slice multiple times.

The task data plane includes at least one PF in the SDP. A PF in the task data plane may receive, process, and/or transmit data during an execution of the task. PFs may act as ingress PFs, egress PFs and/or ingress/egress PFs. Ingress PFs and egress PFs in the task data plane are called border PFs.

An ingress PF, such as PF2 434, PF3 436 shown in FIG. 4, is a PF configured to receive, during a task execution, task input data related to the task execution from a network entity (e.g. a device, an AS, a network function) that does not belong to the task data plane.

An egress PF, such as PF6 442 in FIG. 4, is a PF configured to transmit, during a task execution, task output data related to the task execution to a network entity (e.g. a device, an AS, a network function) that does not belong to the task data plane. The PF may be an ingress PF and also an egress PF (i.e. take the ingress PF role and the egress PF role).

In embodiments, the task data plane does not include ingress PF(s). In embodiments, the task data plane does not include egress PF(s). In embodiments, the task data plane includes both ingress PF(s) and egress PF(s).

A PF in the task data plane that is not a border PF, i.e. the PF is neither an ingress PF nor an egress PF such as PF5 440 or PF4 438, may be referred to as an internal PF.

If the task data plane includes multiple PFs, the multiple PFs may be interconnected (as indicated by the solid lines in FIG. 4). The interconnected PFs may communicate with each other during the task execution using the interconnections (referred to as intra-task connections). The PFs and the interconnections between them form a logical topology of the task data plane.

The task control plane includes one or multiple TCFs. Some TCF(s) in the SCP may be included in the task control plane of the task slice 402 (e.g. TCF2 426 and TCF3 428 in FIG. 4), or excluded from the task control plane of the task slice 402 (e.g. TCF1 424 in FIG. 4). A TCF is associated with one or multiple PFs in the task data plane. The association (as indicated by dashed lines in FIG. 4) may be determined by a SCF in the task control plane. When associated, a TCF is able or allowed to mange or control the associated PFs. Note that a PF in the task data plane (e.g. PF4 438 in FIG. 44) may be associated with multiple TCFs (e.g. TCF2 426 and TCF3 428 in FIG.4) and thus may be managed or controlled by any of the multiple TCFs.

When the task is executed over the corresponding task slice, one, or more than one, TCF in the task control plane of the task slice is selected to manage the task execution. When managing the task execution, a TCF manages or controls (including configures) at least one PF in the task data plane of the task slice to receive, process, and/or transmit data related to the task execution, the at least one PF being associated with the TCF. The at least one PF may be associated with the TCF by an SCF as described above. In some embodiments, a network entity (e.g. a device, an AS, a network function) that does not belong to the task slice may participate in the task execution by communicating with the at least one PF. In this case, the at least one PF is a border PF, e.g. PF2 434, PF3 436, or PF6 442 in FIG. 4, and the TCF may coordinate the communication between the at least one PF and the network entity when managing the task execution.

An ingress PF in the task data plane (e.g. PF2 434, PF3 436 in FIG. 4) may each use one or multiple inbound interfaces for the task. Such an inbound interface is an interface between the ingress PF and a task participant. The ingress PF is associated with inbound interface information describing the one or multiple inbound interfaces. The inbound interface information may be determined by an SMC (e.g. SCF1 420 or SCF2 422 in FIG. 4) in the service control plane.

In some embodiments, the one or multiple inbound interfaces are in the form of API(s) or SBI(s). The one or multiple inbound interfaces may be used/called by the ingress PF through remote procedure call(s) (RPCs). The one or multiple inbound interfaces may be implemented or supported by a task participant. When the task is being executed over the task slice, the ingress PF interacts with the task participant by calling the inbound interface(s) to: a) obtain/receive data (e.g. input data, to be used to achieve the goal of the task) from the task participant; and/or b) provide/send data (e.g. output data, a result of the execution of the task or of achieving the goal of the task) to the task participant.

In this case, the inbound interface information may include: interface identifying information which identifies or specifies one or more inbound interfaces, for instance by including a name or ID of each interface; a list of input parameter(s); and, a list of return value(s) (in other words, result(s)) of the interface. When specifying an input parameter, the name of the parameter and the type (e.g. string, integer, float, binary, octal, hexadecimal) of the parameter may be specified. When specifying a return value, the name or ID of the value, the purpose of the value, and the type (e.g. string, integer, float, binary, octal, hexadecimal) of the value may be specified.

In some embodiments, the one or multiple inbound interfaces are described in terms of data types. In this case, an inbound interface may correspond to one or more types of input data which may be identified and/or received by the ingress PF.

In these embodiments, the inbound interface information includes information about input data that the ingress PF can receive. For example, the information may include data type information (e.g. one or multiple data type IDs) identifying at least one data type for the input data the ingress PF may receive. Generally, the at least one data type identified in the inbound interface information is included in the available data types identified in the task information that specifies possible data types for task input data. The inbound interface information may further include, for each of the at least one data type, data format information (e.g. one or multiple data format ID(s)) identifying respective data format(s) that are supported by or at the ingress PF. The respective data format(s) and their correspondence to the data type are indicated or described in the task information in relation to available task input data. When there are multiple ingress PFs in the task plane, the ingress data information associated with a first ingress PF and that associated with a second ingress PF may be different. In some embodiments, the same ingress data information may be associated with multiple ingress PFs.

An egress PF (e.g. PF6 442 in FIG. 4) in the task data plane may implement or support one or multiple outbound interfaces for the task. Such an outbound interface acts as an interface between the egress PF and a task participant. The egress PF is associated with outbound interface information describing the one or multiple outbound interfaces. The outbound interface information may be determined by an SMC (e.g. SCF2 422 in FIG. 4) in the service control plane.

In some embodiments, the one or multiple outbound interfaces are in the form of API(s) or SBI(s). The one or multiple outbound interfaces may be used/called by the task participant through remote procedure call(s) (RPCs). The one or multiple outbound interfaces may be implemented/supported by the egress PF and will be used/called by the task participant. When the task is being executed over the task slice, the task participant interacts with the egress PF by calling the outbound interface(s) to obtain/receive data (e.g. output data, a result of the execution of the task or of achieving the goal of the task) from the egress PF and/or provide/send data (e.g. input data, to be used to achieve the goal of the task) to the egress PF.

In this case, the outbound interface information may include: outbound interface identifiers, each of which specifies an outbound interface, such as by an interface name or interface ID of each interface; a list of input parameter(s), and a list of return value(s) (or, result(s)) of the outbound interface. When specifying an input parameter, the name of the parameter and the type (e.g. string, integer, float, binary, octal, hexadecimal) of the parameter are specified. When specifying a return value, the name or ID of the value, the purpose of the value, and the type (e.g. string, integer, float, binary, octal, hexadecimal) of the value may be specified.

In some embodiments, the one or multiple outbound interfaces are described in terms of data types. In this case, an outbound interface may correspond to one or more types of output data which may be identified and/or transmitted by the egress PF.

In these embodiments, the outbound interface information includes information about output data that the egress PF can transmit. For example, this may include data type identifying information (e.g. one or multiple data type IDs) that identifies at least one data type for the output data the egress PF may receive. Generally, the at least one data type identified in the outbound interface information is included in the available data types identified in the task information that specifies possible data types for task output data. The outbound interface information may further include, for each of the at least one data type, data format information (e.g. one or multiple data format ID(s)) identifying respective data format(s) that are supported by or at the egress PF. The respective data format(s) and their correspondence to the data type are indicated or described in the task information relating to the task output data. When there are multiple egress PFs in the task plane, the egress data information associated with a first egress PF and that associated with a second egress PF may be different. In some embodiments, the same egress data information may be associated with multiple egress PFs.

An SCF (e.g. SCF1 420 or SCF2 422 in FIG. 4) in the SCP 405 is responsible for selecting the task slice 402 for the task (as further described in the embodiment associated with FIG. 6), so that the task can be executed over the task slice 402 for achieving the goal of the task. When selecting the task slice 402, the SCF selects the task control plane and the task data plane which together support and make up the task slice 402 as described above.

When selecting the task data plane, the SCF determines a logical topology of the task data plane, including selecting component PFs (e.g. PF2 434, PF3 436, PF4 438, PF5 440, PF6 442 in FIG. 4) for the task data plane and determining interconnections between the selected PFs. When selecting the task data plane, the SCF further determines which of the selected PFs are border PFs. A border PF is an ingress PF (e.g. PF2 434, PF3 436 in FIG. 4), or an egress PF (e.g. PF6 442 in FIG. 4), or both an ingress PF and an egress PF (not shown in FIG. 4). For each ingress PF the SCF determines corresponding inbound interface information and, for each egress PF the SCF determines corresponding outbound interface information.

When selecting the task control plane, the SCF selects one or multiple TCFs (e.g. TCF2 426 and TCF3 428 in FIG. 4) and associates the selected TCFs with the task data plane selected by the SCF. In some embodiments, the SCF is further responsible for associating each of the selected TCFs with at least one PF in the task data plane. In FIG. 4, the association represented by dashed lines implies that each TCF (TCF 2426, TCF3 428) is operative to manage or control at least one PF associated with that TCF during an execution of the task over the task slice 402. Note that the SCF may be operative to associate a PF (e.g. PF4 438 in FIG. 4) with multiple TCFs (e.g. TCF2 426, TCF3 428 in FIG. 4) and thus may be managed or controlled by any of the selected TCFs during the task execution.

When selecting the task slice, the SCF may consider and select TCFs to balance loading (e.g. in terms of number of tasks) on the TCFs and on the PFs and to optimize task slice efficiency (e.g. communication overhead/performance like delay, computing overhead/performance like delay). The SCF may store information about the task slice (referred to as task slice information) in a network entity, e.g. NRF. The task slice information describes the makeup of the selected task slice including the TCF(s) and border PF(s) in the task slice and may include some or all of the following information: task identifying information (e.g. a task ID or name); task slice identifying information (e.g. a task slice ID or name); task data plane identifying information; and/or, task control plane identifying information.

The task data plane identifying information identifies the border PFs in the task data plane. This may be in the form, for instance, of a list of border PF IDs or network addresses, each border PF identifier associated with a border PF of the task slice. For each identified border PF, the task data plane identifying information may further include interface information (i.e. inbound interface information, outbound interface information, or both) that is associated with that identified border PF.

The task control plane identifying information identifies the TCFs in the task control plane that are part of the task slice. This may be in the form, for instance, of a list of TCF IDs or network address, each TCF identifier corresponding with a TCF selected for the task slice. For each identified TCF, the task control plane identifying information may further include association information that describes any associations between border PFs and selected TCFs for the task slice. The association descriptions may further indicate whether a border PF may be managed or controlled by associated TCFs.

FIG. 5A is a simplified schematic of a communication system architecture according to embodiments of the present disclosure. The communication system 500 includes a control plane 505. The control plane 505 includes multiple network functions that, while shown is single entities for simplicity in FIG. 5A, may be replicated throughout the communication system 500 as may be required or relevant. The network functions include, for instance: connectivity manager (CM) 522, mission manager (MM) 524, policy manager (PM)526, mission data repository (MDR) 512, network registry function (NRF) 514, mission information handler (MIH) 516. These network functions are also referred to as control plane functions (CPFs). The MDR 512 stores mission information and task information, while the NRF 514 stores task slice information. In some embodiments, the NRF 514 is commonly known as a network repository function, e.g. in the 5G system standard. The MIH 516 handles requests from AF 528 for mission information provisioning as further described below.

The communication system 500 further includes a service module 560 that in turn includes a service control plane (SCP) 569 and a service data plane (SDP) 568 as described elsewhere in this invention disclosure. The SCP 569 includes one or multiple service module controllers (SMCs), which are logical network functions. In the SCP 569, there may be two types of SMCs: service control function (SCF) 566 and task control function (TCF) 564. An SMC may be both an SCF 566 and a TCF 564. The SCP 569 is part of the control plane of the communication system 500. The SDP 568 includes at least one PF 562, which is a logical network function that receives, processes, and/or transmits data.

The communication system 500 further includes a connection plane 550 which together with the SDP 568 of the service module 560 form a data plane of the communication system 500. The connection plane 550 connects a device 520 (e.g. a UE, an IoT device, a robot, a vehicle), the SDP 568 of the service module 560 (i.e. the PF 562 in the SDP 568), and a data network (DN) 590 such that they can communication with each other. The connection plane 550 in the example of FIG5 includes at least one radio access network (RAN) node 552 and at least one connection plane function (NPF) 554, which is a logical network function. The SDP of the service module connects with the DN via the NPF. The SDP 568 of the service module 560 connects with the device 520 via the RAN node 552 and the NPF 554. The device 520 connects with the DN 590 via the RAN node 552 and the NPF 554. In some embodiments, the NPF 554 is integrated within the RAN node 552.

Logical network functions in the communication system 500, e.g. those described above, can be deployed or instantiated at various network locations. Some of the logical network functions may be integrated. For example, the NPF 554 and the PF 562 are integrated in some embodiments, and the SCF 566 and the TCF 564 are integrated in some embodiments.

The communication system 500 provides information about one or multiple service(s) offered by the service module 560 to the AF 528. The information is referred to as service information. The service information comprises information describing, for each of the one or multiple services, service problems associated with the service, e.g. a problem ID, application category ID and a meta data, wherein the problem ID identifies the service problem, the application ID identifies an application category that the service problem belongs to or is associated with, and the meta data provides further information that can be used by the AF 528 to understand the service and the service problem. The meta data may, for instance, indicate performance of the service in solving the service problem.

The service information may be provided from a logical network function, e.g. a service data repository (SDR) in the communication system 500 to the AF 528. The SDR is not shown in FIG. 5A. In some embodiments, the service information is provided from the SDR to the AF 528 via the MIH 516. In some embodiments, the SDR is integrated with the MDR 512. In some embodiments, the SDR is integrated with the NRF 514. In some embodiments, the SDR is integrated with the MIH 516. According to the service information, the AF 528 creates a mission, such as mission 105 described above. The AF 528 compiles/generates a mission information describing the mission and provisions the mission information to the communication system 500. Content of the mission information is described above with reference to FIG. 2. The communication system 500 prepares resources for the mission according to the mission information so that the mission can be executed. If the mission is reusable, as indicated by the AF 528 in the mission information, the communication system 500 can provide the mission information (in some embodiments, except for the mission specification in the mission information) to some AF 528 (e.g. via the MIH 516) so that the mission can be reused to as a building block of a new mission. Mission information provisioning by the AF 528, and preparation of resources such as mission slices by the communication system 500, is described below with reference to FIG. 6.

FIG. 5B is an alternative communication system architecture embodiment that lacks an NPF 554. In the embodiment of FIG. 5B the RAN 552 and the AS 592 connect directly to the PF 562, rather than through the NPF 554.

In some embodiments, as illustrated in FIG. 5B, a PF 562 may connect directly to a second PF 562 through a connection 572 so that that the PFs 562 can communicate directly. The second PF 562 is not shown in FIG. 5B. In these embodiments at least some of the functionality of an NPF 554 may be provided by the PFs 562.

In some embodiments, an alternative communication system architecture as illustrated in FIG. 5A may include an NPF 554 in addition to the PF 562. In these embodiments, the communication between the PF 562 illustrated and a second PF 562 (not shown in FIG. 5A) is indirect, through the NPF 554 shown, a second NPF 554 (not shown in FIG. 5A), the connection 570 between the NPF 554 and the PF 562, and a second connection 579 between the second NPF 554 and the second PF 562 (not shown in FIG. 5A). In some embodiments, the second NPF 554 and the NPF 554 may be the same entity.

FIG. 6 is an illustrative embodiment of a simplified schematic of mission information provisioning and mission resource preparation. In mission provisioning step 1, the AF 528 sends the mission information related to a mission to the MIH 516. The mission information may be included in an AF request (or a mission information provisioning request) sent from the AF 528 to the MIH 516.

The MIH 516 evaluates the received mission information and determines whether the mission information can be accepted based on content included in the mission information. For instance, if the mission information sent from the AF 528 includes a mission specification, the mission information is considered fully specified and can be accepted by the MIH 516. The MIH 516 may then send a response to the AF 528 (i.e. an AF response or a mission information provisioning response) indicating that the mission can be accepted.

If the mission information is not fully specified (i.e. if the mission information does not include a mission specification), the mission information should (or is expected to) include a mission intent. If the unspecified mission information lacks a mission intent, then the mission information is not valid and cannot be accepted by the MIH 516. If the mission information cannot be accepted based on content included in the mission information, the MIH 516 rejects the mission information and indicates the rejection to the AF 528 by sending a response to the AF 528 (i.e. an AF response or a mission information provisioning response) indicating that the mission cannot be accepted, such as step 4 in FIG. 6.

If the unspecified mission information is valid (e.g. the mission information includes a mission intent), in intent translation step 2 the MIH 516 performs a mission intent translation to fully specify the mission information. In step 2 the MIH 516 interacts with one or multiple SCFs (e.g. SCF 1 566-1, SCF 2 566-2, … , SCF n 566-n) over multiple sub-steps 2.1, 2.2, …, 2.n to obtain the specified mission information.

If the mission information is fully specified (whether as received from the AF 528 or as a result of the intent translation step 2 performed by the MIH 516 to successfully generate a mission specification), in mission information storage step 3 the MIH 516 transmits the specified mission information to the MDR 512 for storage. After storing the specified mission information in the MDR 512, in step 4 the MIH 516 may transit an AF response (or a mission information provisioning response) that notifies (or indicates to) the AF 528 that the mission information is specified. In some aspects, the AF response may further confirm that the mission information was accepted, the specified mission information was stored in the MDR 512, and/or that the mission information provisioning is successful.

When performing the intent translation, the MIH 516 generates a mission specification for the mission according to the mission intent in the mission information and updates the unspecified mission information to a specified mission information by including the generated mission specification in the updated mission information. The MIH 516 uses one or multiple SCFs 566-1, 566-2, …, 566-n to generate the mission specification, as described in more detail below.

In intent translation step 2, the MIH 516 sends the unspecified mission information, including the mission intent, to an intent translation SCF (e.g. one of SCF 1 566-1, SCF 2 566-2, … , SCF n 566-n) operative to generate a mission specification based on the mission intent and the MIH 516 receives the mission specification from the mission intent translation SCF. The intent translation SCF is selected by the MIH 516 according to the target service information included in the mission intent. The intent translation SCF is an SCF in the service module that offers the service identified in the target service information (i.e. the target service). In response to receiving the mission specification, the intent translation SCF generates the mission specification according to the mission intent for the mission and sends the mission specification to the MIH 516. In some embodiments, step 2 is performed in multiple sub-steps, wherein multiple SCFs may be selected to perform the intent translation to generate the mission specification as further described below.

When generating the mission specification, the intent translation SCF may create one or multiple tasks as BBs of the mission, the one or multiple tasks being supported by the target service and identified by a list of task identifiers (e.g. task ID(s) or names). The list of task ID(s) are generated by the intent translation SCF. The intent translation SCF generates a task information for each of the one or multiple tasks, the task information including the corresponding task ID. The content of the task information is described above with reference to FIG. 4. The intent translation SCF may store the task information in the service module (e.g. in a storage function associated with the service module). When storing the task information, the intent translation SCF may include the task information corresponding to the one or multiple tasks in the mission specification (e.g. in the composition information in the mission specification).

When generating the mission specification, the intent translation SCF may further include one or multiple sub-missions in the mission as BBs. The one or multiple sub-missions are identified by a list of sub-mission ID(s). The intent translation SCF includes the list of sub-mission ID(s) in the mission specification (e.g. in the composition information in the mission specification).

In some embodiments, a sub-mission in the one or multiple sub-mission maps (corresponds) to an existing mission, and the intent translation SCF indicates the mapping, and includes a mission ID of the existing mission in the mission specification (e.g. in the composition information in the mission specification). The intent translation SCF may discover or select an existing mission by accessing the MDR 512, which stores mission information of the existing mission, to retrieve additional information relating to that mission.

In some embodiments, a sub-mission in the one or multiple sub-missions is not an existing mission, for example, when the intent translation SCF determines from the unspecified mission information that the sub-mission is needed as a BB of the mission and no existing missions are suitable for it. When the intent translation SCF determines that a sub-mission is not an existing mission, the intent translation SCF creates a new mission as the sub-mission and generates a mission ID to identify the new mission. The intent translation SCF maps the sub-mission to the new mission, and the intent translation SCF indicates the mapping, and includes the mission ID of the new mission in the mission specification (e.g. the composition information in the mission specification includes the mission ID of the new mission).

In some embodiments, the intent translation SCF uses the sub-mission ID as the mission ID of the new mission. The intent translation SCF further generates a mission information for the new mission, which is referred to as sub-mission information. The sub-mission information includes the mission ID of the new mission and a mission intent of the new mission.

The intent translation SCF determines interconnection(s) the BBs of the mission and describes the interconnections in the composition information in the mission specification. The intent translation SCF further determines a mission graph (workflow) for the mission and one or multiple access points for the mission, and describes/specifies the mission graph and the one or multiple access points respectively in the mission workflow information and the access point information in the mission specification.

After completion of the mission specification, the intent translation SCF sends the mission specification to the MIH 516 for the MIH 516 to generate the specified mission information. If one or more than one sub-mission in the mission (which is identified in the composition information in the mission specification) is not an existing mission, the intent translation SCF may indicate so to the MIH 516 and also send the corresponding one or more than one sub-mission information to the MIH 516, e.g. together with the mission specification. In this case, the MIH 516 accordingly performs an intent translation for every one of the one or more than one sub-mission to fully specify the corresponding sub-mission information, following the same logic as described above, wherein the MIH 516 may interact with one or multiple intent translation SCFs (selected from SCF 1 566-1, SCF 2 566-2, … , SCF n 566-n) (e.g. the steps 2.2 – 2.n), and the MIH 516 transmits the fully-specified sub-mission information to the MDR 512 for storage as well (i.e. step 3).

Before sending the mission information to the MDR 512 for storage in the MDR 512 (step 3), the MIH 516 may further process the mission information. The mission information processing may be related to a sub-mission in the mission and may involve using the MDR 512 as described below. Recall that the sub-mission of the mission corresponds to a reuse of another mission. The reused mission is identified in the mission specification (e.g. the composition information) of the mission information.

If the reused mission is an existing mission, the MIH 516 may validate the reuse. If the reused mission is a new mission created by an intent translation SCF during the intent translation step 2, the MIH 516 skips the reuse validation (i.e. does not validate the reuse). The MIH 516 will determine that the reused mission is a new mission based on information received from the intent translation SCF that created the new mission. For example, if the MIH 516 receives from the intent translation SCF a sub-mission information for the sub-mission, or if the MIH 516 receives from the intent translation SCF an indication indicating that the reused mission is a new mission, the MIH 516 can accordingly determine that the reused mission is a new mission.

When validating the reuse, the MIH 516 first obtains a reusability information that indicates whether the reused mission is reusable. If the reused mission is reusable, the reusability information further indicating whether the reused mission is in the exclusive reuse mode or in the sharable reuse mode. In some embodiments, the reusability information is stored in the MDR 512 as part of the mission information of the reused mission, and is obtained by the MIH 516 from the MDR 512.

If the MIH 516 attempts to obtain the reusability information from the MDR 512 and if the MIH 516 cannot, or fails to obtain the reusability information from the MDR 512 (e.g. because the reused mission is not an existing mission), the MIH 516 will consider the reuse (and thus the mission information) is invalid. If the reusability information indicates that the reused mission is indeed reusable, the reuse valid, and invalid otherwise. If the reuse is invalid, the MIH 516 will not store the mission information in the MDR 512 (that is, will not perform the step 3), and the MIH 516 will notify the AF 528 about the rejection through an AF response sent to the AF 528 (AF response step 4).

If the reused mission is a new mission created by an intent translation SCF during the intent translation (e.g. step 2), or if the reusability indication described above indicates that the reused mission is in the exclusive reuse mode, the MIH 516 may unfold the sub-mission to reduce the mission hierarchy and updates/modifies the mission specification accordingly (i.e. to reflect the unfolding).

The unfolding is reflected by the MIH 516 updating/modifying the mission specification such that the composition information in the mission specification identifies BBs (task(s) and sub-mission(s)) of the reused mission as BBs of the mission and does not identify the reused mission as a BB in the mission specification. As such, the mission information that the MIH 516 sends to the MDR 512 for storage (step 3) includes the updated/modified mission specification that reflects the unfolding.

After or during provisioning of the mission information, the communication system may perform mission resource preparation, i.e. preparing resources (including creating a mission slice) for the mission, according to the mission information. If the mission includes one or multiple tasks, a task slice may be created for each of the one or multiple tasks during the mission resource preparation, the task slice being part of the mission slice. The mission resource preparation may be initiated by the MIH and involves one or multiple SCFs, as described below.

In some embodiments, the MIH initiates the mission resource preparation after provisioning of the mission information when a certain mission resource triggering condition is met. Examples of triggering conditions include the MIH: receiving a mission resource request (e.g. from the AF 528) for the mission resource preparation to be initiated; and/or receiving an access notification (e.g. from the access manager (AM)) of a mission participant request for access to the mission.

The mission resource request and the access notification may include mission identifying information identifying (e.g. a mission ID) the mission and application identifying information (e.g. an application ID) identifying an application that the mission is to be used for or associated with. In this case, the MIH may obtain the mission information from the MDR using the mission identifying information (e.g. mission ID) if the MIH does not have the mission information locally.

In some embodiments, the MIH 516 initiates the mission resource preparation during the provisioning of the mission information described above in relation to FIG. 6. In this case, the AF request received from the AF 528 for mission information provisioning (step 1) may include the application identifying information (i.e. an application ID).

Mission slice identifying information is used to identify the mission slice and may be referred to as a mission slice ID. The mission slice can be identified by the mission identifying information and the application identifying information. Thus, in some embodiments, the mission identifying information and the application identifying information can together be simply referred to as mission slice ID. In some embodiments, a mission slice ID is allocated (e.g. by the MIH) to identify the mission slice

During the mission resource preparation, the MIH 516 interacts with (i.e. instructs) one or multiple task slice creation SCFs 566 (e.g. selected from SCF 1 566-1, SCF 2 566-2, … , SCF n 566-n) to create a task slice for each of the one or multiple tasks. In some embodiments, when the mission specification of the mission is translated from a mission intent during the provisioning of the mission information as described above in relation to FIG. 6, the task slice creation SCF(s) 566 may be the intent translation SCF(s). The MIH 516 further stores a task slice information describing each task slice in the NRF 514 (task slice information storage step 5). As indicated in FIG. 6, the task slice information storage may occur in multiple sub-steps (e.g. steps 5.1, 5.2, …, 5.n), each sub-step corresponding to an interaction between one of the multiple task creation SCFs that is generating the task slice information and storing the generated task slice information in the NRF 514. The content of the task slice information is described above in relation to FIG. 4. In some embodiments, the task slice information storage may be realized through self-registration, wherein each network entity (e.g. PF, TCF) in every task slice registers itself with the NRF 514. When a network entity registers itself register with the NRF 514, the network entity provides information related to itself in the task slice information to the NRF 514, e.g. information identifying the network entity (an ID or a network address), task slice identifying information (such as the task slice ID) that identifies the task slice, and mission slice identifying information (such as the mission ID) that identifies the mission slice, etc. If the network entity is a PF, the network entity may further provide TCF information that indicates or identifies TCFs associated with the PF in the task slice. If the network entity is a TCF, the network entity may further provide PF information that indicates or identifies PFs associated with the TCF in the task slice.

The mission resource preparation may take place at different stages in the process. For instance, mission resource preparation may occur between the intent translation step 2 and the mission information storage step 3; after step 3 and before the obtaining mission information step 6 and obtaining task slice information step 7; as part of (i.e. integrated with) the intent translation step 2 when the mission resource preparation is performed during the provisioning of the mission information; or at another point in the process as may be relevant.

For each task, the MIH 516 selects a task slice creation SCF (e.g. selected from SCF 1 566-1, SCF 2 566-2, … , SCF n 566-n) according to the service identifying information in the task information included in the mission information, and the MIH 516 sends a task slice creation request to the task slice creation SCF to create a task slice for the task. The task slice creation request may include, for instance, the task information. The task slice creation SCF may be selected by the MIH 516 from those available SCFs in the SCP of a service module that offers the service identified in the service identifying information included in the task information. In some embodiments, when the task belongs to a mission created during an intent translation for a sub-mission of the mission, the task slice creation SCF may be the intent translation SCF that creates that mission. The MIH 516 will receive a task slice creation response from the task slice creation SCF that indicates that the task slice requested by the MIH 516 in the task slice creation request has been created.

When creating the task slice, the task slice creation SCF selects a task data plane and a task control plane. When selecting the task data plane, the task slice creation SCF selects one or more PFs from the SDP of the service module and includes the selected PFs in the task data plane. The task slice creation SCF may further determine a logical topology among the PFs (i.e. how they are interconnected) in the task data plane. The task slice creation SCF may further determine which of the PFs in the task data plane are border PFs (i.e. ingress PFs and/or egress PFs) of the task data plane. When selecting the task control plane, the task slice creation SCF selects one or more TCFs from the SCP of the service module and includes the selected TCFs in the task control plane. The task slice creation SCF may further associate each PF in the task data plane with a TCF in the task control plane. The association indicates that the associated TCF is available or allowed to manage or control the PF during an execution of the task over the task slice. The task slice creation SCF configures the task data plane by configuring the PFs and configures the task control plane by configuring the TCFs.

When configuring the PFs, the task slice creation SCF provides task slice identifying information (e.g. the task slice ID) that identifies the task slice and mission slice identifying information (e.g. the mission slice ID) that identifies the mission slice to the PFs. The task slice creation SCF provides the PFs with interconnection information about interconnections between the PFs as determined by the task slice creation SCF when determining the logical topology among the PFs. The task slice creation SCF further provide each of the PFs with information indicating whether the PF is an ingress PF and/or an egress PF of the task data plane. The task slice creation SCF further provides each of the PFs with TCF information that indicates or identifies any associated TCFs (e.g. TCF ID or address) in the task control plane that are associated with that PF in relation to the created task slice.

When configuring the TCFs, the task slice creation SCF provides task slice identifying information (e.g. the task slice ID) and mission slice identifying information (e.g. the mission slice ID) to the task TCFs. The task slice creation SCF also provides each of the TCFs with PF information that indicates or identifies associated PFs (e.g. associated PF ID or address) in the task data plane that are associated with that TCF.

In task slice information storage step 5, the task slice creation SCF sends task slice information describing the task slice to the NRF 514 for storage. The content of the task slice information is described above in relation to FIG. 4. The task slice information includes information identifying the mission slice (i.e. mission slice identifying information, such as a mission slice ID). The task slice creation SCF further sending the task slice creation response to the MIH 516. The MIH 516 will may further send a task slice creation confirmation to the task slice creation SCF that acknowledges or confirms the creation of the requested task slice.

The order of operations in task slice information storage step 5 may vary. For instance, in some embodiments the task slice creation SCF stores the task slice information in the NRF 514 before sending the task slice creation response to the MIH 516. In some embodiments, the task slice creation SCF stores the task slice information after receiving the task slice creation confirmation from the MIH 516. In some embodiments, the MIH 516 sends the task slice creation confirmation to the task slice creation SCF after the MIH 516 receives a task slice creation response for all of the multiple task slice creation requests sent by the MIH 516 in relation to the mission slice. In some embodiments, the MIH 516 may send the task slice creation confirmation to the task slice creation SCFs before or after the MIH 516 stores the mission information in the MDR 512 in mission information storage step 3.

If the mission includes one or multiple sub-missions, the one or multiple sub-missions correspond to one or more than one existing mission. For such an existing mission, if no mission slices have been created, the MIH 516 may perform mission resource preparation to create a mission slice for the existing mission and includes it in the mission slice as a sub-mission slice corresponding to the sub-mission. The existing mission may be associated with one or multiple mission slices. The MIH 516 selects one of the one or multiple mission slices and includes it in the mission slice as a sub-mission slice corresponding to the sub-mission. The MIH 516 sends a sub-mission slice information that describes the sub-mission slice to the NRF 514 for storage. The sub-mission slice information may comprise any of the following: sub-mission identifying information (e.g. a sub-mission ID) identifying the sub-mission; mission identifying information (e.g. a mission ID) identifying the mission; mission slice identifying information (e.g. a mission slice ID) identifying the mission slice; existing mission identifying information (e.g. a mission ID) identifying the existing mission that corresponds to the sub-mission; or, selected mission slice information (e.g. a mission slice ID) identifying the selected mission slice of the existing mission for the sub-mission.

The mission slice information stored in the NRF 514, either by an SCF or the MIH 516 during the mission resource preparation, collectively describes the mission slice. A mission manager (MM) 524 may obtain the mission slice information from the NRF 514 and use it together with the mission information, available from the MDR 512, to establish intra-mission connections, as further described below. In some embodiments, the intra-mission connections are considered part of the mission slice.

The mission slice may be established through multiple steps. The mission slice establishment steps may occur as a single procedure, or may be distributed through multiple procedures. For example, a task slice in the mission slice may be created by a task slice creation SCF during mission resource preparation (e.g. during intent translation step 2 described above in relation to FIG. 6), while sub-mission slices in the mission slice may be established before mission provisioning (e.g. before the mission provisioning step 1 described in relation to FIG. 6). Intra-mission connections in the mission slice may be established after the mission resource preparation, for example, by a mission manager (MM) 524.The MM 524 may establish the intra-mission connections according to mission information describing the mission and task slice information describing the task slices.

The mission information may be provisioned from the AF 528 as described above in relation to FIG. 6 and obtained by the MM 524 from the MDR 512, as illustrated by the obtaining mission information step 6 in FIG. 6. The task slice information may be stored in the NRF 514 as described above in relation to FIG. 6 and obtained by the MM 524 from the NRF 514, as illustrated by the obtaining task slice information step 7 in FIG. 6. The MM 524 may be selected by the MIH 516, or by a connectivity Manager CM 522 based on a device request, to manage an execution of the mission over the mission slice. When the MM 524 is selected by a CM 522 based on a device request, the device request may be a request from a device 520 for accessing the execution of the mission, and the device request is sent from the device 520 to the CM 522. In either case, the MM 524 receives a request (e.g. a mission management request), from the CM 522 or the MIH 516, the request including information identifying the mission (e.g. mission identifying information).

After the intra-mission connections are established, the intra-mission connections may be re-established to improve mission slice efficiency according to: network dynamics (e.g. mobility/location change of mission participants, change in network congestion, loading and resource availability, number of mission participants), or mission execution requirement changes. The re-established intra-mission connections may be referred to as new intra-mission connections and the intra-mission connections prior to the re-establishment may be referred to as old intra-mission connections. The new intra-mission connections may include some, none, or all of the old intra-mission connections.

When establishing an intra-mission connection, the MM 524 associates an egress PF from a first task slice in the mission slice, the first task slice corresponding to a first task in the mission, and an ingress PF from a second task slice in the mission slice, the second task slice corresponding to a second task in the mission. In some embodiments, the MM 524 may further configure a tunnel between the egress PF and the ingress PF. The egress PF is associated with outbound interface information that describes one or multiple outbound interfaces of the egress PF. The ingress PF is associated with inbound interface information that describes one or multiple inbound interfaces of the ingress PF. When associating the egress PF and the ingress PF, the MM 524 ensures that the one or multiple outbound interfaces of the egress PF are compatible with the one or multiple outbound interfaces of the ingress PF based on the interface information.

In the case that the outbound interfaces and the inbound interfaces are in the form of APIs or SBIs they are considered to be interface compatible if the APIs or SBIs of the outbound interfaces match or map to the APIs or SBI of the inbound interfaces. The interfaces may be matched or mapped based on an evaluation of the interface name/ID, interface parameters, and return values, as described in the outbound interface information and the inbound interface information described above including in relation to FIG. 4.

In the case that the outbound interfaces and the inbound interfaces correspond to output data and input data they are considered to be data compatible if data types and respective formats associated with the output data match those associated with the input data, as described in the outbound interface information and the inbound interface information described above including in relation to FIG. 4.

In some embodiments, whenever, an intra-mission connection is created or established (e.g. due to establishment or re-establishment), the MM 524 may store an intra-mission connection information describing the intra-mission connection in a network entity, e.g. the NRF 514 or the MDR 512 or some other network function. The intra-mission connection information includes information identifying the mission slice (mission slice identifying information), e.g. a mission slice ID or name, an association information and a tunnel information.

The association information indicates access point identifying information about the egress PF, e.g. an ID or network address and information of the ingress PF, e.g. an ID or network address of the intra-mission connection. For each of the egress PF and the ingress PF, this information may further include task slice identifying information for the task slice that the PF belongs to. The task slice belonging to the mission slice is identified in the mission slice identifying information.

The tunnel information includes information identifying the connection or tunnel (e.g. a connection ID or a tunnel ID). The tunnel information may further include information about the two tunnel end points (e.g. two tunnel end point IDs), each being associated with one of the two PFs. The tunnel may further include protocol information about a protocol used for the tunnel (e.g. a protocol ID or name). The protocol may be, for instance, QUIC, GTP-U, TCP, UDP, or any combination of them.

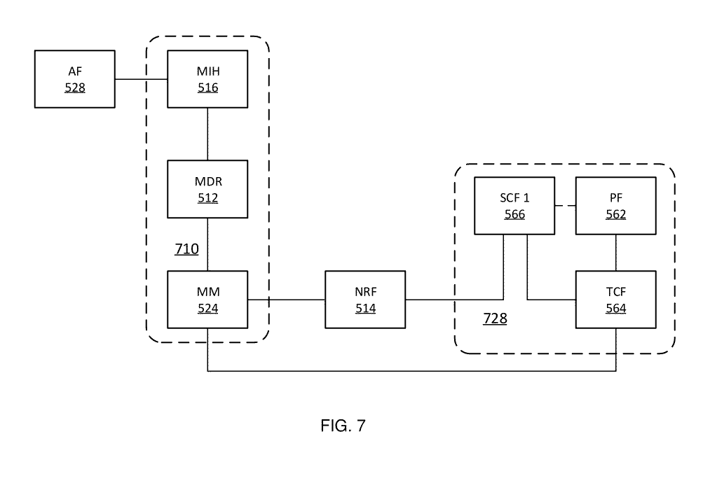

FIG. 7 is an illustration of an embodiment of a simplified schematic of a mission management framework (MMF). In the embodiment of FIG. 7 an AF 528 is operative to provide mission information to a MIH 516. The MIH 516 is operative to: process the mission information, including optionally unfolding sub-missions within the mission; and, expose mission information (i.e. mission intent) and service information. A MDR 512 is in operative communication with the MIH 516 and a MM 524 and is operative to receive, store, and provide mission information. A MM 524 is operative to manage mission execution and is further in operative communication with a TCF 564 that is operative to support tasks created for the mission and NRF 514 that is operative to store task slice information (including border PF information and related mission TCFs). A service module 728 includes at least one of each of a SCF 566 for establishing the task slice, a PF 562 for processing data traffic, and a TCF 564 for managing task execution.

In some embodiments, a network entity 710 may include or integrate various components as a same entity. For instance, in the embodiment of FIG. 7, the MIH 516, MDR 512, and the MM 524 are integrated as a single entity 710. In some embodiments the MIH 516 and the MM 524 may be integrated as a same entity. In some embodiments, the MDR 512 and the NRF 514 may be integrated as a same entity. In some embodiments, the MIH 516, MDR 512, and the MM 524 and NRF 514 may be integrated as a same entity. In some embodiments, the SCF 566 and the TCF 564 may be integrated as a same entity.

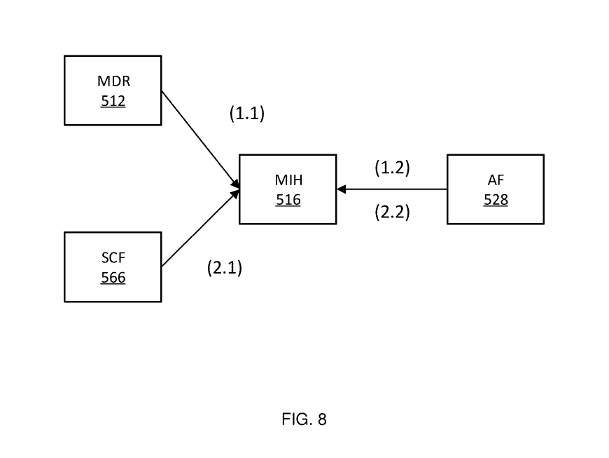

FIG. 8 is an illustration of an embodiment of a simplified schematic of mission / service information exposure. In the embodiment of FIG. 8, an MDR 512 may send mission information of a mission to a MIH 516 (step 1.1) for delivery to an AF 528 (step 1.2). The mission information may include, for instance, a mission identifying information (e.g. a mission ID), a reusability indication and a mission intent. The content of the mission information is described above, including in relation to FIGS. 3 and 6 for instance. An SCF 566 may send service information of a service to the MIH 516 (step 2.1) for delivery to the AF 528 (step 2.2). The service information may include, for instance, service identifying information (e.g. a service ID), service problem information and application category information. Content of the service problem information and content of application category information are described elsewhere in this application including in relation to FIG. 2 for instance. In some instances, the service problems may be allocated per application category for convenience.

In some embodiments, the MDR 512 sends the mission information and/or the SCF 566 sends the service information based on an initial request or subscription sent by the AF 528 to the MDR 512 and SCF 566 respectively. In some aspects, the request or subscription may further indicate spatial condition(s), and/or temporal condition(s) for the request. The spatial conditions may indicate one or multiple locations (or areas). When the spatial condition(s) is (are) indicated by the request or subscription, the MDR 512 and/or the SCF 566 accordingly send the service information of the service only if the service is available in a location (or area) indicated by the spatial condition(s). The temporal condition(s) may indicate one or multiple times (e.g. in terms of time intervals, windows, or durations). When the condition condition(s) is (are) indicated by the request or subscription, the MDR 512 and/or the SCF 566 accordingly send the service information of the service only if the service is available in during a time indicated by the spatial condition(s).

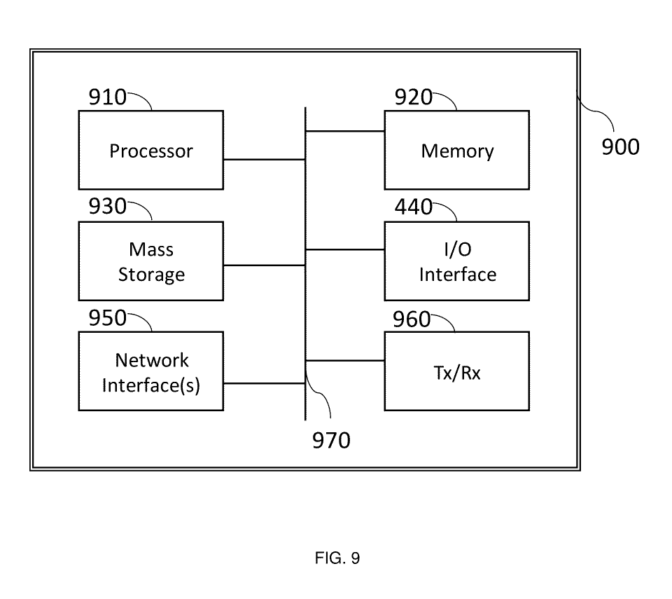

FIG. 9 is a schematic diagram of a computing device 900 that may perform any or all of operations of the methods and features explicitly or implicitly described herein, according to different embodiments of the present disclosure. For example, a computer equipped with network function may be configured as the computing device 900. One, two or more such computing devices may be coupled together in order to provide embodiments of the present disclosure. Multiple physically separate devices (e.g. in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 900 may include a processor 910, such as a Central Processing Unit (CPU) or specialized processors such as a Graphics Processing Unit (GPU) or other such processor unit, memory 920, non-transitory mass storage 930, input-output interface 440, network interface 950, and a transceiver 960, all of which are communicatively coupled via bi-directional bus 970. According to certain embodiments, any or all of the depicted elements may be utilized, or only a subset of the elements. Further, device 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure and invention(s) associated therewith have been described with reference to specific features and embodiments, it is evident that various modifications and combinations can be made thereto without departing from such invention(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its invention(s).

What is claimed is:

1. A method in a communication network, the method comprising:
receiving mission information related to a mission;
determining whether the mission information is able to be accepted based on content included in the mission information; and
sending a response to an application function (AF) indicating whether the mission is able to be accepted.

2. The method of claim 1, wherein determining whether the mission information is able to be accepted further comprises, sending the mission information to a mission data repository (MDR) for storage.

3. The method of claim 1, wherein determining whether the mission information is able to be accepted based on the content included in the mission information comprises:
when the mission information includes a mission specification, determining the mission information is able to be accepted.

4. The method of claim 3, wherein the mission specification includes composition information, workflow information, and access point information.

5. The method of claim 1, wherein determining whether the mission information is able to be accepted based on the content included in the mission information comprises:
when the mission information does not include a mission specification, determining whether the mission information includes a mission intent that describes a goal of the mission; and
when the mission information does not include a mission intent, determining that the mission information is to be rejected.

6. The method of claim 1, wherein determining whether the mission information is able to be accepted based on the content included in the mission information comprises:
when the mission information does not include a mission specification, determining whether the mission information includes a mission intent that describes a goal of the mission; and
when the mission information includes a mission intent, performing mission intent translation to generate a mission specification based on the mission intent, and determining whether the mission information is able to be accepted based on the generated mission specification.

7. The method of claim 6, wherein performing the mission intent translation comprises generating a mission specification for the mission according to the mission intent and updating the mission information by including the generated mission specification to specify the mission information.

8. The method of claim 6, wherein the mission specification is generated by creating at least one building block (BB) of the mission as defined in the mission information, and wherein the mission specification includes composition information identifying the at least one BB.

9. The method of claim 8, wherein the at least one BB includes a task or a sub-mission related to the mission information, and wherein the composition information further comprises at least one of:
task identifying information of the mission, sub-mission identifying information of the mission, or interconnection information related to tasks or sub-missions of the mission.

10. The method of claim 8, wherein the composition information identifies a plurality of BBs, and wherein the composition information further comprises interconnection information that identifies interconnections between the plurality of BBs.

11. The method of claim 8, wherein the composition information identifies a plurality of BBs, and wherein the mission information further comprises access point information that identifies which BBs are access points of the mission.

12. The method of claim 11, wherein the access point information further identifies which access points are ingress points or egress points of the mission.

13. The method of claim 8, wherein the mission information further comprises workflow information that describes or specifies ordering or timing between BBs identified in the composition information.

14. The method of claim 13, wherein the workflow information further indicates dependency between the BBs identified in the composition information.

15. The method of claim 13, wherein the workflow information further indicates, for at least one BB identified in the composition information, temporal conditions related to execution of that BB.

16. The method of claim 6, wherein performing the mission intent translation comprises:
communicating with one or more service control functions (SCFs) that provide services related to the mission intent; and
receiving, from the one or more SCFs, the generated mission specification.

17. The method of claim 16, wherein communicating with the one or more service control functions (SCFs) comprises:
sending, to the one or more SCFs, the mission intent, and wherein the generated mission specification is generated by the one or more SCFs based on the mission intent.

18. The method of claim 1, further comprising initiating mission resource preparation.

19. The method of claim 18, wherein initiating the mission resource preparation comprises:
initiating the mission resource preparation in response to receiving a mission resource request from an application function (AF) or an access notification from an access manager (AM) of a mission participant requesting access to the mission.

20. An apparatus comprising:
one or more processors; and
one or more memories storing instructions which, when executed by the one or more processors, cause the apparatus to:
receive mission information related to a mission;
determine whether the mission information is able to be accepted based on content included in the mission information; and
send a response to an application function (AF) indicating whether the mission is able to be accepted.
